(19) United States
(12) Patent Application Publication
(10) Pub. No.: US 2024/0078452 A1
(43) Pub. Date: Mar. 7, 2024

(54) DATASET GENERATION SYSTEM, SERVER, AND NON-TRANSITORY COMPUTER-READABLE RECORDING MEDIUM RECORDING DATASET GENERATION PROGRAM

(71) Applicant: AWL, Inc., Tokyo (JP)

(72) Inventors: Fadoua GHOURABI, Tokyo (JP); Yasuhiro TSUCHIDA, Tokyo (JP); Xiaotian SI, Tokyo (JP)

(73) Assignee: AWL, Inc., Tokyo (JP)

(21) Appl. No.: 18/455,726

(22) Filed: Aug. 25, 2023

(30) Foreign Application Priority Data
Aug. 26, 2022 (JP) 2022-135256

(51) Int. Cl. G06N 5/04; G06F 16/55

(52) U.S. Cl. CPC G06N 5/04; G06F 16/55

(57) ABSTRACT

A dataset generation system has a camera classification circuitry configured to classify plural cameras into plural groups, an input device for a user to set a selecting criterion of a captured image, a first captured image collection circuitry configured to collect captured images which are captured by at least one camera in each group classified by the camera classification circuitry, and which meet the selecting criterion set by a user using the input device, an inference circuitry configured to perform inference processing on each of the captured images collected by the first captured image collection circuitry and a dataset evaluation circuitry configured to evaluate whether or not a dataset consisting of the captured images collected by the first captured image collection circuitry is suitable for a training dataset of a neural network model for a predetermined inference process, based on the result of the inference processing by the inference circuitry.

### CROSS-REFERENCE TO RELATED APPLICATION

This application is based on and claims the benefit of priority of the prior Japanese Patent Application No. 2022-135256, filed on Aug. 26, 2022, the entire contents of which are incorporated herein by reference.

### BACKGROUND OF THE INVENTION

### 1. Field of the Invention

The present invention relates to a dataset generation system, a server, and a non-transitory computer-readable recording medium recording a dataset generation program.

### 2. Description of the Related Art

Conventionally, there has been known a system that performs image analysis (object detection or object recognition) of an image captured by a camera installed in a facility such as a store of a convenience store by a device (what is called edge-side device) arranged on a facility side where the above-described camera is installed (see, for example, JP 2018-88157 A). In a case where inference processing for image analysis such as object detection and object recognition is performed in such an edge-side device, a learned deep neural network model (DNN model) with a small processing load (what is called “light”) is implemented in the edge-side device, and the inference processing on the captured image of the camera connected to the edge-side device is performed using the learned DNN model. Here, in view of the vulnerability of computer resources in the edge-side device, the learned DNN model implemented in the edge-side device described above is desirably an extremely light (very small processing load) DNN model. The DNN model to be implemented in the edge-side device as described above is generally generated by a server connected to the edge-side device performing machine learning on the basis of a captured image from the camera installed in the above-described facility (see, for example, paragraphs (0037) and (0038) of JP 2018-88157 A).

However, in a case where the above-described extremely light (very small processing load) learned DNN model is mounted on an edge-side device arranged in a large number of facilities such as chain stores, and inference processing is performed on captured images of cameras of numerous facilities, there are the following problems. That is, in a case of using the extremely light learned DNN model as described above, it is desirable to perform fine tuning of the original learned DNN model (learned DNN model for inference processing such as object detection and object recognition) using a captured image of a camera of the corresponding facility in order to ensure accuracy. However, in a case of a major chain store (convenience store or the like), the number of stores is several 1000 stores, and if fine tuning of the original learned DNN model is performed using captured images of all cameras arranged in several 1000 stores, long processing time is required, and the cost required to transfer the captured image of the camera from the edge-side device to the server (communication cost, electricity cost, and the like) and the cost required to store the captured image of the camera received by the server from the edge-side device (cost required to secure the storage area in the server) increase. The above problem is a common problem not only in a case where the original learned DNN model is fine-tuned using the captured images of cameras of numerous facilities such as chain stores as described above, but also in a case where the machine learning of the DNN model for inference processing (for example, a DNN model for object detection or object recognition) targeting the captured images of the cameras of the numerous facilities such as chain stores is performed.

### BRIEF SUMMARY OF THE INVENTION

The present invention solves the above problems, and an object thereof is to provide a dataset generation system, a server, and a non-transitory computer-readable recording medium recording the dataset generation program that enable machine learning of a neural network model for inference processing targeting captured images of cameras of numerous facilities such as chain stores with as few captured images as possible.

In order to solve the above problem, a dataset generation system according to a first aspect of the present invention comprises a camera classification circuitry configured to classify plural cameras into plural groups, an input device for a user to set a selecting criterion of a captured image, a first captured image collection circuitry configured to collect captured images which are captured by at least one camera in each group classified by the camera classification circuitry, and which meet the selecting criterion set by a user using the input device; an inference circuitry configured to perform inference processing on each of the captured images collected by the first captured image collection circuitry, and a dataset evaluation circuitry configured to evaluate whether or not a dataset consisting of the captured images collected by the first captured image collection circuitry is suitable for a training dataset of a neural network model for a predetermined inference process, based on the result of the inference processing by the inference circuitry.

In the above configuration, captured images that meet the selecting criteria set by the user are collected from at least one or more cameras in each group, and it is possible to evaluate whether or not the dataset including the captured images collected at that time is suitable for the learning dataset of the neural network model for predetermined inference processing. Thus, when the evaluation value of the dataset including the captured image collected at that time becomes equal to or more than a target value, the collection of the captured image is ended, and the dataset including the captured image collected at that time can be set as the learning dataset of the neural network model for predetermined inference processing, so that the number of captured images included in the learning dataset of the neural network model for predetermined inference processing can be reduced as much as possible. Therefore, it is possible to perform machine learning of the neural network model (for example, a neural network model for object detection or object recognition) for predetermined inference processing targeting captured images of cameras of numerous facilities such as chain stores with as few captured images as possible. Therefore, the processing time necessary for generating the learning dataset of the neural network model for predetermined inference processing and the processing time necessary for machine learning of the neural network model using the learning dataset can be shortened.

A server according to a second aspect of the present invention comprises a camera classification circuitry configured to classify the plural cameras into plural groups, an input device for a user to set a selecting criterion of a captured image, a first captured image collection circuitry configured to collect captured images which are captured by at least one camera in each group classified by the camera classification circuitry, and which meet the selecting criterion set by a user using the input device, an inference circuity configured to perform inference processing on each of the captured images collected by the first captured image collection circuitry, and a dataset evaluation circuitry configured to evaluate whether or not a dataset consisting of the captured images collected by the first captured image collection circuitry is suitable for a training dataset of a neural network model for a predetermined inference process, based on the result of the inference processing by the inference circuitry.

In this configuration, it is possible to obtain an effect similar to that of the dataset generation system according to the first aspect.

A non-transitory computer-readable recording medium according to a third aspect of the present invention records a dataset generation program for causing a computer to execute a process including the steps of classifying plural cameras into plural groups, collecting captured images which are captured by at least one camera in each of the classified groups, and which meet the selecting criterion set by a user using an input device, performing inference processing on each of the collected captured images; and evaluating whether or not a dataset consisting of the collected captured images is suitable for a training dataset of a neural network model for a predetermined inference process, based on the result of the inference processing.

A similar effect to that of the dataset generation system according to the first aspect can be obtained using the dataset generation program recorded in the recording medium.

### BRIEF DESCRIPTION OF THE DRAWINGS

The present invention will be described hereinafter with reference to the annexed drawings. It is to be noted that the drawings are shown for the purpose of illustrating the technical concepts of the present invention or embodiments thereof, wherein:

FIG. 1 is a block configuration diagram showing a schematic configuration of a dataset generation system according to an embodiment of the present invention;

FIG. 2 is a block diagram showing a schematic hardware configuration of a signage in FIG. 1;

FIG. 3 is a block diagram showing a hardware configuration of an analysis box in FIG. 1;

FIG. 4 is a block diagram showing a hardware configuration of a learning server in FIG. 1;

FIG. 5 is a functional block configuration diagram of the learning server;

FIG. 6 is a flowchart of learning dataset generation processing in the dataset generation system;

FIG. 7 is a flowchart showing details of processing (clustering processing) of S11 to S13 in FIG. 6;

FIG. 8 is a diagram showing a user interface screen to be used at the time of designing a subsystem for the clustering processing;

FIG. 9 is a diagram showing a user interface screen to be used at the time of designing a subsystem for selecting and collecting a frame image from a representative camera;

FIG. 10 is a diagram showing an example of a frame image selection algorithm according to the selecting criteria set in S14 in FIG. 6;

FIG. 11 is a diagram showing a user interface screen to be used at the time of designing a subsystem for quality evaluation of a dataset composed of frame images collected from the representative camera;

FIG. 12 is a diagram showing a user interface screen to be used at the time of designing a subsystem for evaluation through fine tuning of a dataset for which it is determined in S19 in FIG. 6 that a comprehensive evaluation value of quality has reached a KPI; and

FIG. 13 is a sequence diagram showing a flow of frame image data collection in the dataset generation system.

### DETAILED DESCRIPTION OF THE INVENTION

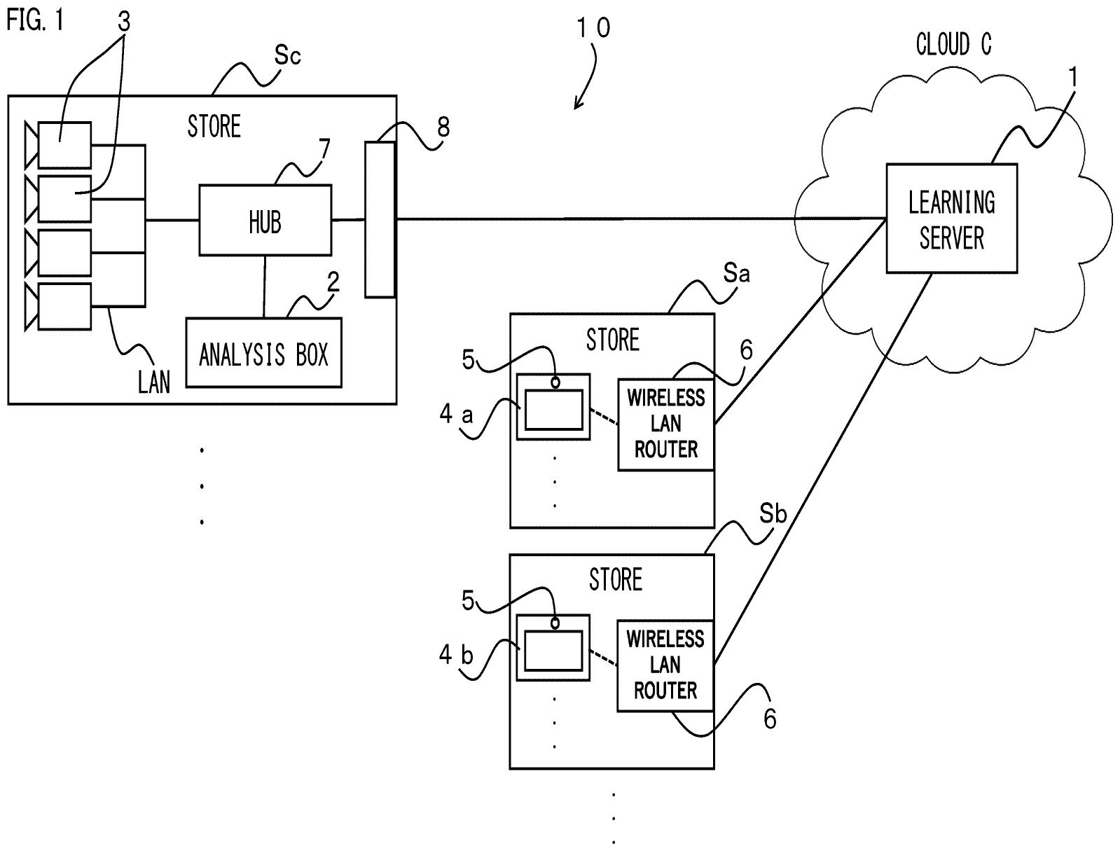

Hereinafter, a dataset generation system, a server, and a non-transitory computer-readable recording medium for recording a dataset generation program according to an embodiment embodying the present invention will be described with reference to the drawings. FIG. 1 is a block configuration diagram showing a schematic configuration of a dataset generation system 10 according to the present embodiment. As shown in FIG. 1, in the present embodiment, an example will be described in which a plurality of fixed cameras 3, which are monitoring network cameras for capturing images of a predetermined image-capturing area, and an analysis box 2 for analyzing a video from each fixed camera 3 are arranged in a store Sc or the like such as a chain store, and a signage 4 (a collective term for signage 4a, 4b, or the like), which is a tablet terminal for digital signage including a built-in camera 5, is arranged in stores Sa and Sb and the like such as a chain store.

The above-described dataset generation system 10 mainly includes the plurality of fixed cameras 3, the analysis box 2, and the signage 4 installed in each store S (a collective term for stores Sa, Sb, Sc, and the like), and a learning server 1 (corresponding to “server” and “computer” in claims) on the cloud C connected to the analysis box 2 and the signage 4 via the Internet.

As shown in FIG. 1, the above-described dataset generation system 10 includes a hub 7 and a router 8 in a store Sc in which the fixed camera 3 and the analysis box 2 are arranged. In addition, the dataset generation system 10 includes a wireless LAN router 6 in the stores Sa, Sb, and the like in which the signage 4 is arranged. Note that the camera on the signage 4 side may be the built-in camera 5 disposed in the housing of the signage 4, or may be a web camera attached to the signage 4, but in the following description, an example in which the camera on the signage 4 side is the built-in camera 5 will be mainly described. The “plurality of cameras” in the claims includes a built-in camera 5 of each signage 4 and each fixed camera 3 connected to each analysis box 2.

The above-described fixed camera 3 has an IP address and can be directly connected to a network. As shown in FIG. 1, the analysis box 2 is connected to a plurality of fixed cameras 3 via a local area network (LAN) and a hub 7, and analyzes an image input from each of the fixed cameras 3. Specifically, the analysis box 2 performs object detection processing (detection processing of a customer and the head/face of a customer) on an image input from each of the fixed cameras 3, object recognition processing (recognition processing such as customer attribute (gender and age (age group)) estimation and posture estimation) on an image of an object detected in the object detection processing, and the like.

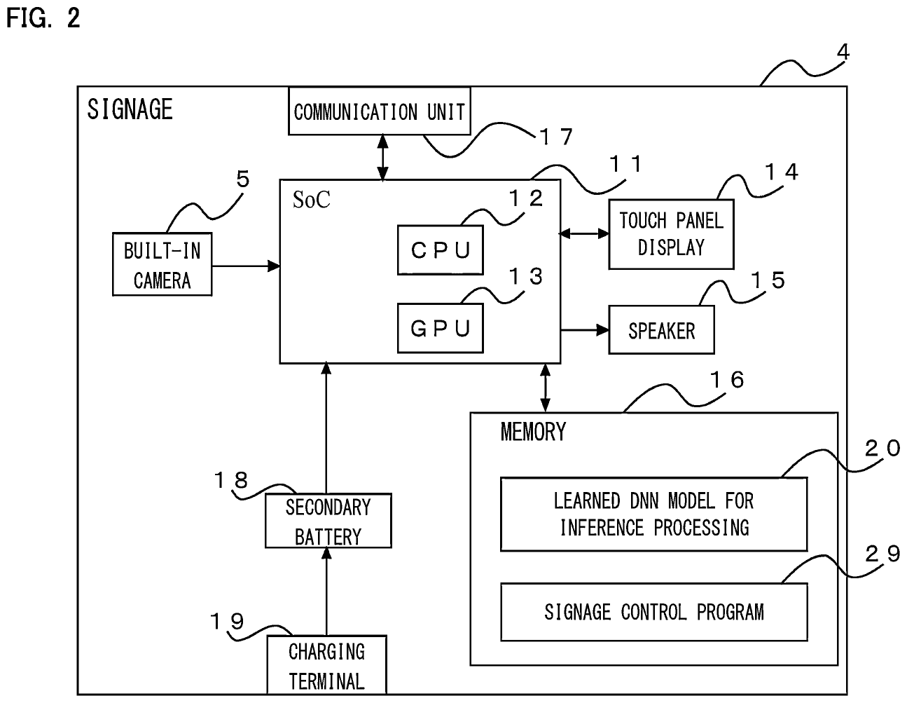

The signage 4 is mainly installed on a product shelf in the store S, and displays content such as an advertisement for a customer who visits the store S on a touch panel display 14 (see FIG. 2), and performs the object detection processing (detection processing of a customer and the head/face of a customer) on a frame image from the built-in camera 5, the object recognition processing on an image of an object detected in the object detection processing, and the like.

The above-described learning server 1 is a server installed in a management department (head office or the like) of the store S. Although details will be described later, the learning server 1 generates (a dataset suitable for) a learning dataset of a deep neural networks (DNN) model for predetermined inference processing, performs fine tuning of an original learned DNN model for inference processing using the generated learning dataset, and transmits the learned DNN model after the fine tuning to each analysis box 2 and each signage 4 to install.

Next, a hardware configuration of the above-described signage 4 will be described with reference to FIG. 2. In addition to the above-described built-in camera 5, the signage 4 includes a system-on-a-chip (SoC) 11, the touch panel display 14, a speaker 15, a memory 16 that stores various data and programs, a communication unit 17, a secondary battery 18, and a charging terminal 19. The SoC 11 includes a CPU 12 that controls the entire device and performs various calculations, and a CPU 13 used for inference processing of various learned deep neural network (DNN) models 20 for inference processing, and the like.

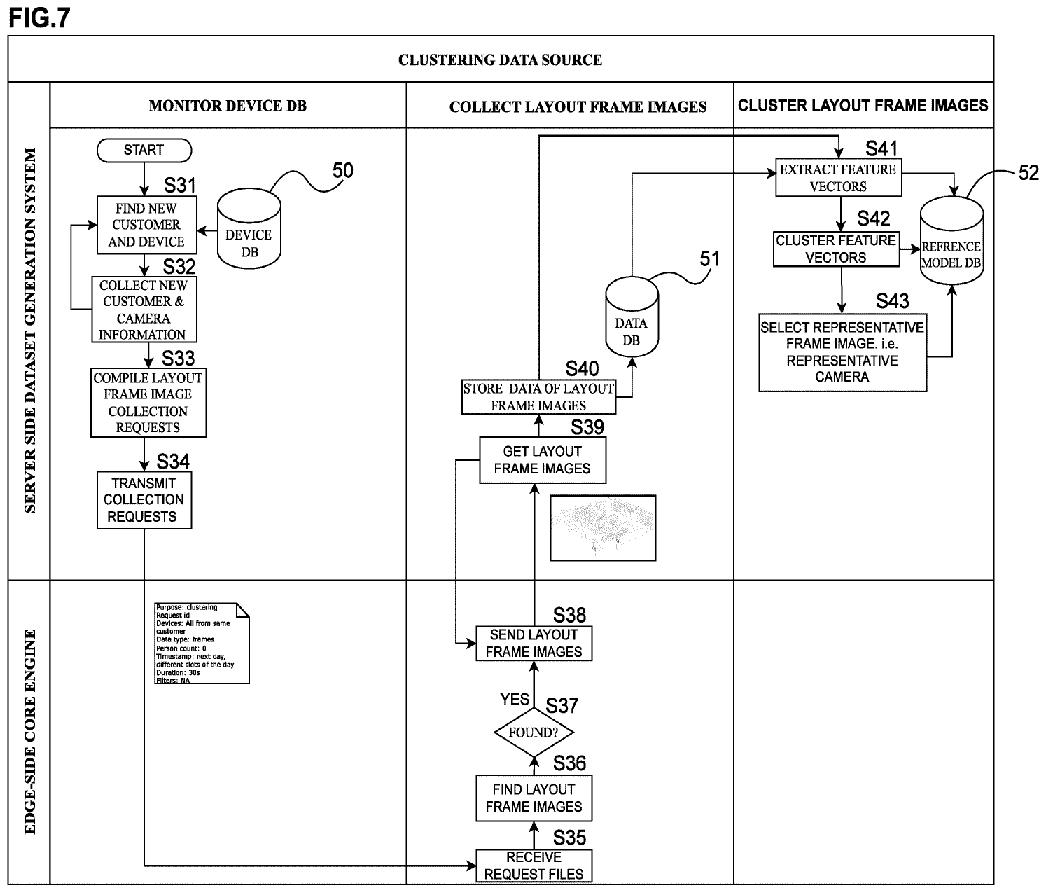

The above-described memory 16 stores a learned DNN model 20 for inference processing. The learned DNN model 20 for inference processing includes a plurality of types of learned DNN models for inference processing, and includes, for example, a learned DNN model for detection of a customer (person) (including a learned DNN model for detection of a face or head of a customer) and a learned DNN model for object recognition processing (recognition processing such as customer attribute (gender and age (age group)) estimation and posture estimation) on an image of a customer (person) or the head/face of a customer detected by the above-described detection processing. Note that the program stored in the memory 16 includes a signage control program 29 which is a program corresponding to the “edge-side core engine” in FIG. 7.

The above-described communication unit 17 includes a communication IC and an antenna. The signage 4 is connected to the learning server 1 on the cloud C via the communication unit 17 and the Internet. Further, the secondary battery 18 is a battery that can be repeatedly used by charging, such as a lithium ion battery, and stores power from a commercial power supply after being converted into DC power by an AC/DC converter, and supplies the power to each part of the signage 4.

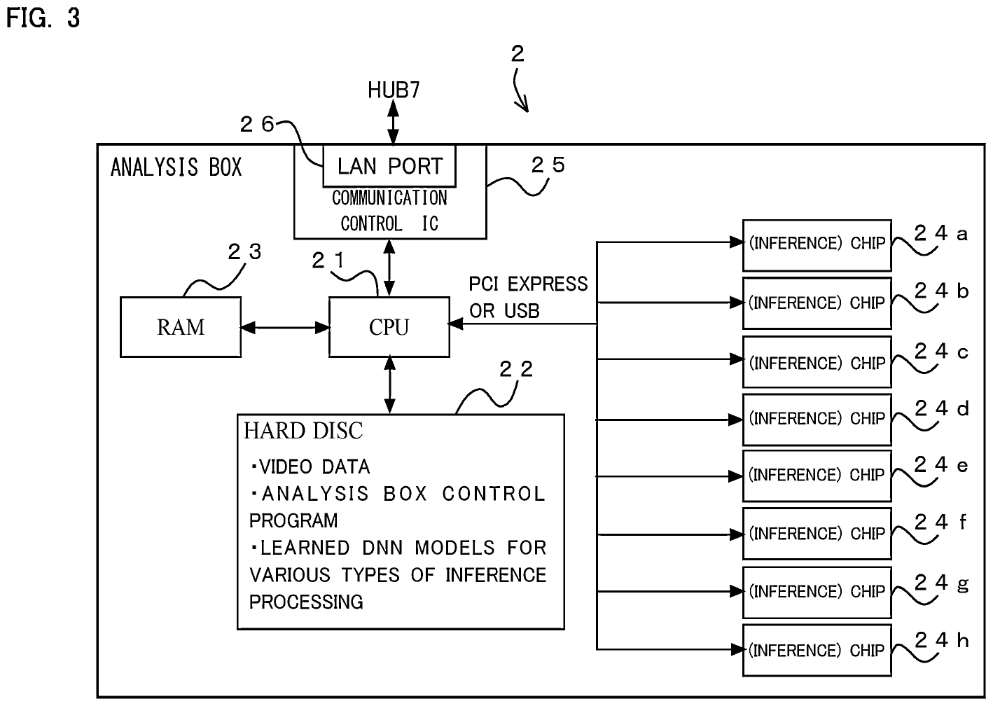

Next, a hardware configuration of the analysis box 2 will be described with reference to FIG. 3. The analysis box 2 includes a CPU 21 that controls the entire device and performs various calculations, a hard disk 22 that stores various data and programs, a random access memory (RAM) 23, inference chips (hereinafter, abbreviated as “chip”) 24a to 24h that are processors for deep neural networks (DNN) inference, and a communication control IC 25. The CPU 21 is a general purpose CPU or a CPU designed to improve parallel processing performance for simultaneously processing a large number of video streams. Further, the data stored in the hard disk 22 includes video data obtained by decoding (the data of) a video stream input from each of the fixed cameras 2. Furthermore, the program stored in the hard disk 22 includes learned DNN models (learned DNN models for various types of inference processing) for inference processing such as human detection processing, face detection processing, attribute recognition processing, and posture estimation processing, and an analysis box control program. Note that the above-described analysis box control program includes a program corresponding to the “edge-side core engine” in FIG. 7.

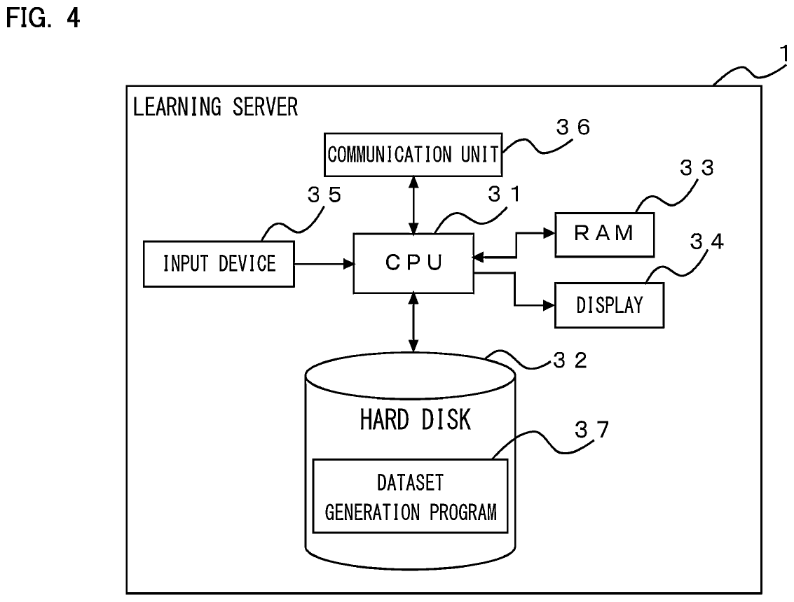

Next, a hardware configuration of the learning server 1 will be described with reference to FIG. 4. The learning server 1 includes a CPU 31 that controls the entire device and performs various calculations, a hard disk 32 that stores various data and programs, a random access memory (RAM) 33, a display 34, an input device 35, and a communication unit 36. The program stored in the above-described hard disk 32 includes a dataset generation program 37.

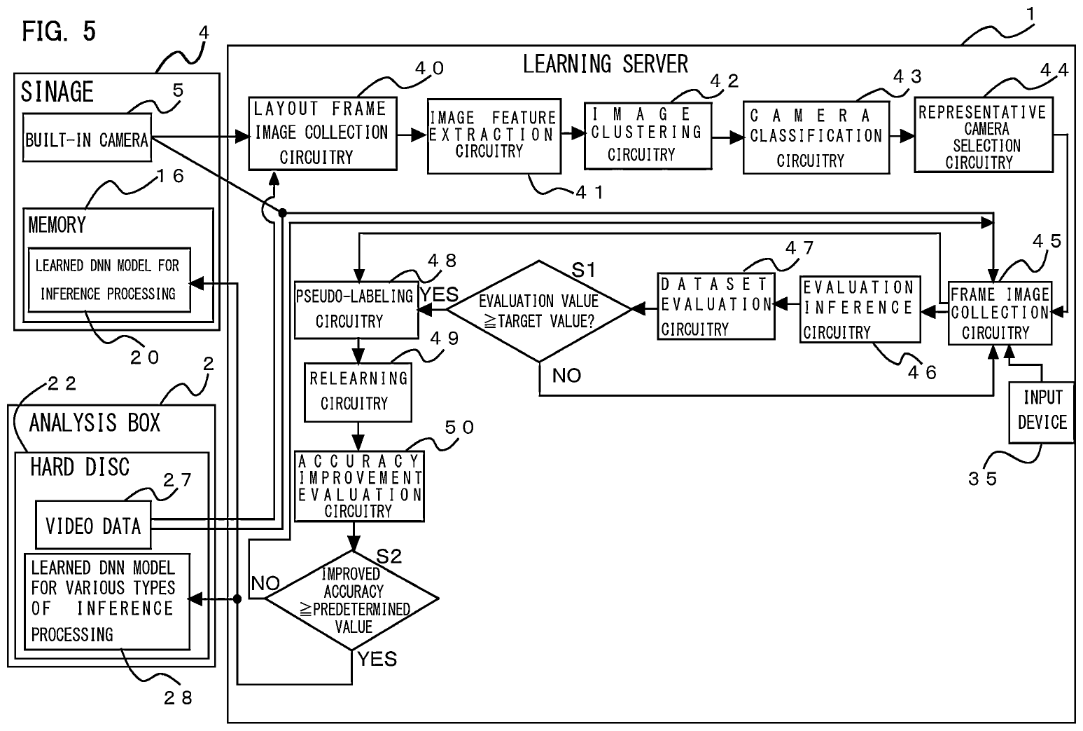

FIG. 5 mainly shows functional blocks of the above-described learning server 1. In the following description of FIG. 5, the correspondence relationship between each functional block in the drawing and each component (each circuitry) in the claims and the outline of the function of each functional block will be described. The learning server 1 includes, as functional blocks, a layout frame image collection circuitry 40, an image feature extraction circuitry 41, an image clustering circuitry 42, a camera classification circuitry 43, a representative camera selection circuitry 44, a frame image collection circuitry 45, an evaluation inference circuitry 46, a dataset evaluation circuitry 47, a pseudo-labeling circuitry 48, a relearning circuitry 49, and an accuracy improvement evaluation circuitry 50. The layout frame image collection circuitry 40, the image feature extraction circuitry 41, the image clustering circuitry 42, the camera classification circuitry 43, the representative camera selection circuitry 44, the frame image collection circuitry 45, the evaluation inference circuitry 46, the dataset evaluation circuitry 47, the pseudo-labeling circuitry 48, the relearning circuitry 49, and the accuracy improvement evaluation circuitry 50 described above correspond to a second captured image collection circuitry, an image feature extraction circuitry, an image clustering circuitry, a camera classification circuitry, a representative camera selection circuitry, a first captured image collection circuitry, an inference circuitry, a dataset evaluation circuitry, a pseudo-labeling circuitry, a relearning circuitry, and an accuracy improvement evaluation circuitry in the claims, respectively. In addition, the layout frame image collection circuitry 40 and the frame image collection circuitry 45 described above are mainly achieved by the communication unit 36, the CPU 31, and the dataset generation program 37 in FIG. 4. In addition, the above-described image feature extraction circuitry 41, the image clustering circuitry 42, the camera classification circuitry 43, the representative camera selection circuitry 44, the evaluation inference circuitry 46, the dataset evaluation circuitry 47, the pseudo-labeling circuitry 48, the relearning circuitry 49, and the accuracy improvement evaluation circuitry 50 are achieved by the CPU 31 and the dataset generation program 37 in FIG. 4.

Upon finding a new data source (a camera (including both the built-in camera 5 of the signage 4 and the fixed camera 3 connected to the analysis box 2) installed in a store of a new customer or a camera newly installed in a store of an existing customer) as a result of checking the device DB (see FIG. 7), the above-described layout frame image collection circuitry 40 acquires captured images (frame images) without a person from each of the new camera(s). In the following description, the frame image in which only the background of a store is reflected without a person is referred to as a layout frame image. The image feature extraction circuitry 41 extracts features from each of layout frame images (captured images showing no person) collected by the layout frame image collection circuitry 40. The image clustering circuitry 42 groups the layout frame images collected by the layout frame image collection circuitry 40 on the basis of the features extracted by the image feature extraction circuitry 41. The camera classification circuitry 43 groups the cameras (the built-in camera 5 and the fixed camera 3) that have captured these layout frame images on the basis of the result of grouping the layout frame images by the image clustering circuitry 42, thereby grouping the plurality of new cameras described above. The representative camera selection circuitry 44 selects a representative camera in each group grouped by the camera classification circuitry 43.

The frame image collection circuitry 45 collects, from each of the representative cameras selected by the representative camera selection circuitry 44, a frame image showing a person and meeting selecting criteria set by a system administrator using the input device 35 such as a mouse. At this time, the frame image collection circuitry 45 desirably collects frame images in which the number of people has increased, the positions of more than a predetermined percent of persons have moved, or the postures of more than a predetermined percent of persons have changed, as viewed from the previous frame image. Note that, in the present embodiment, since inference processing performed by a DNN model (for predetermined inference processing) as a target (inference processing of the same type as the inference processing performed by the learned DNN model for inference processing of the edge-side device) is inference processing related to a person (since the recognition target is a person (exactly speaking, a person, a face, or a head)), a case where the frame image collected by the frame image collection circuitry 45 is a frame image showing a person will be described as an example, but the frame image collected by the frame image collection circuitry 45 does not need to be a frame image showing a person, and may be a frame image in which a recognition target other than a person, such as an animal, a vehicle, or a product, appears. Note that, in a case where the recognition target is other than a person, the frame image collection circuitry 45 desirably collects frame images in which the number of recognition targets has increased, the positions of more than a predetermined percent of persons have moved, or the postures of more than a predetermined percent of persons have changed, as viewed from the previous frame image. The evaluation inference circuitry 46 performs inference processing for evaluation on each of the frame images collected by the frame image collection circuitry 45.

On the basis of the result of the inference processing by the evaluation inference circuitry 46, the dataset evaluation circuitry 47 evaluates whether or not a dataset including a frame image collected by the frame image collection circuitry 45 is suitable for the learning dataset of the DNN model for predetermined inference processing. More specifically, the dataset evaluation circuitry 47 evaluates whether or not the dataset including the frame image collected by the frame image collection circuitry 45 is suitable as the learning dataset for fine tuning of the learned DNN model for predetermined inference processing described above on the basis of the result of the inference processing by the evaluation inference circuitry 46. When an evaluation value of the dataset by the above-described dataset evaluation circuitry 47 is not equal to or more than a target value (NO in S1), the CPU 31 of the learning server 1 repeats the collection of the frame image showing a person by the frame image collection circuitry 45 until the evaluation value is equal to or more than the target value. When the system administrator determines that it is necessary in the middle of the above repetition, the system administrator adds or changes the selecting criteria of the frame image using the input device 35, and then instructs the CPU 31 of the learning server 1 to repeat the collection of the frame image showing a person by the frame image collection circuitry 45. Note that, in a case where the CPU 31 of the learning server 1 determines that the evaluation value of the dataset by the dataset evaluation circuitry 47 is not equal to or more than the target value in the determination of S1 described above, when it is determined that there is a bias (there is class imbalance) in the class of each frame image in the dataset, the CPU performs processing of removing (deleting) a part of the frame images belonging to the majority class from the dataset.

When the evaluation value of the dataset by the above-described dataset evaluation circuitry 47 is equal to or more than the target value (YES in S1), the relearning circuitry 49 performs fine tuning (one type of relearning) of the learned DNN model for predetermined inference processing using the dataset including the frame image collected by the frame image collection circuitry 45 as the learning dataset. More specifically, when the evaluation value of the dataset is equal to or more than the target value (YES in S1), the pseudo-labeling circuitry 48 performs pseudo-labeling processing on each of the frame images collected by the frame image collection circuitry 45. Then, the relearning circuitry 49 performs fine tuning of the learned DNN model for predetermined inference processing on the basis of the frame image collected by the frame image collection circuitry 45 and a correct answer label given to each frame image by the pseudo-labeling circuitry 48.

The accuracy improvement evaluation circuitry 50 evaluates whether or not the accuracy of the inference processing by the learned DNN model after the fine tuning by the above-described relearning circuitry 49 is improved by a predetermined value or more as compared with the accuracy of the inference processing by the learned DNN model before the fine tuning. When the accuracy of the inference processing by the above-described learned DNN model after the fine tuning is not improved by the predetermined value or more (NO in S2), the CPU 31 of the learning server 1 repeats the collection of the frame image showing a person by the frame image collection circuitry 45, the pseudo-labeling processing by the pseudo-labeling circuitry 48, the fine tuning processing of the learned DNN model for inference processing by the relearning circuitry 49, and the accuracy evaluation processing by the accuracy improvement evaluation circuitry 50 until the accuracy of the above-described inference processing is improved by the predetermined value or more. When the system administrator determines that it is necessary in the middle of the above repetition, the system administrator adds or changes the selecting criteria of the frame image using the input device 35, and then instructs the CPU 31 of the learning server 1 to repeat the processing by the frame image collection circuitry 45, the pseudo-labeling circuitry 48, the relearning circuitry 49, and the accuracy improvement evaluation circuitry 50 described above.

Note that, from the viewpoint of achieving class balance (balancing) in (the frame image of) the Teaming dataset, when the accuracy of the inference processing by the above-described learned DNN model after the fine tuning is not improved by the predetermined value or more (NO in S2), the CPU 31 of the learning server 1 desirably repeats the collection (or deletion of a frame image for balancing the class to which each frame image in the dataset belongs) of the frame image showing a person by the frame image collection circuitry 45, the inference processing by the evaluation inference circuitry 46, evaluation processing of the dataset by the dataset evaluation circuitry 47, the determination processing as to whether or not the evaluation value of the dataset of S1 described above is equal to or more than a target value, the pseudo-labeling processing by the pseudo-labeling circuitry 48, and the fine tuning processing of the learned DNN model for inference processing by the relearning circuitry 49 until the accuracy of the above-described inference processing is improved by the predetermined value or more.

When the evaluation value by the accuracy improvement evaluation circuitry 50 is improved by the predetermined value or more (YES in S2), the CPU 31 of the learning server 1 transmits the learned DNN model after the fine tuning by the relearning circuitry 49 to the edge-side device (the signage 4 corresponding to a new built-in camera 5 and the analysis box 2 connected to a new fixed camera 3) corresponding to the camera included in the new data source and has the learned DNN model stored by using the communication unit 36. More specifically, the CPU 31 of the learning server 1 has the learned DNN model after the fine tuning by the relearning circuitry 49 described above stored as the learned DNN model 20 for inference processing in the memory 16 of the signage 4 corresponding to the new built-in camera 5, and stored as a learned DNN model 28 for various types of inference processing stored in the hard disk 22 of the analysis box 2 connected to the new fixed camera 3.

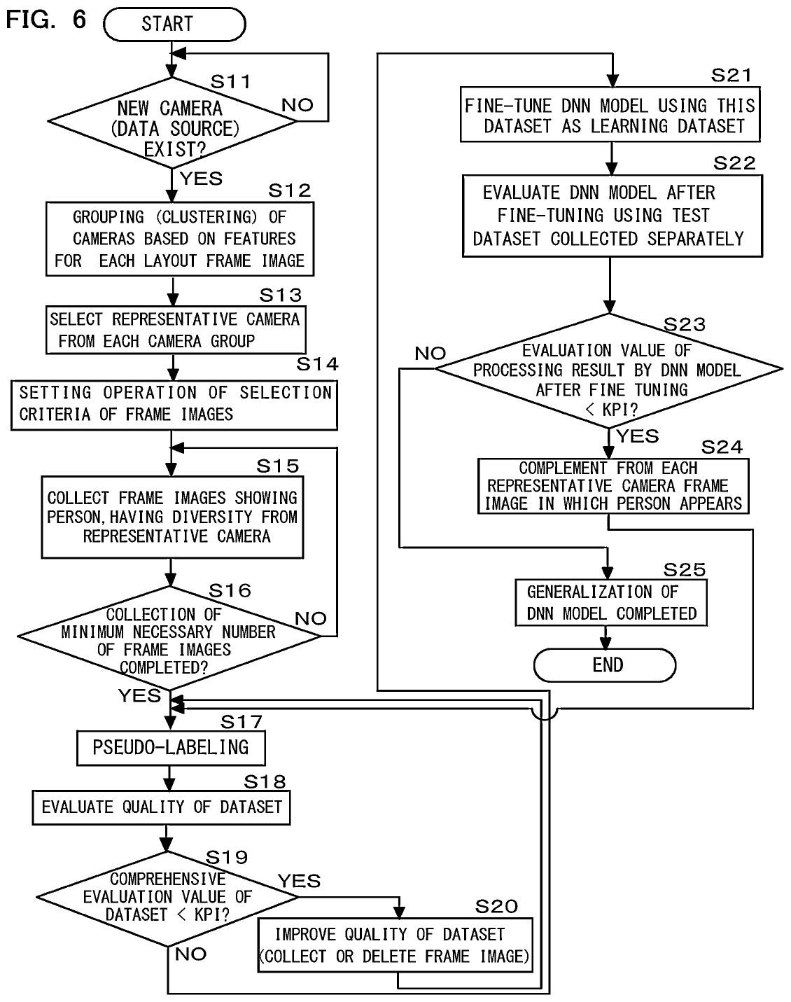

Next, an overall processing flow in the present dataset generation system 10 and a screen for a user interface (UI) used by the system administrator on the learning server 1 side will be described with reference to FIGS. 6 to 13. In a flowchart of FIG. 6, when the CPU 31 of the learning server 1 finds a new data source (a camera (including both the built-in camera 5 of the signage 4 and the fixed camera 3 connected to the analysis box 2) installed in a store of a new customer or a camera newly installed in a store of an existing customer) as a result of checking the device DB 50 shown in FIG. 7 (YES in S11), the above-described layout frame image (captured image showing no person) is collected from each of the new cameras, and grouping (clustering) the cameras (the built-in camera 5 and the fixed camera 3) that have captured the above-described collected layout frame image is performed on the basis of features for each of the collected layout frame images (S12). Then, (the representative camera selection circuitry 44 of) the CPU 31 of the learning server 1 selects a representative camera in each of the groups into which the above-described grouping has been performed (S13).

Details of the processing (clustering processing) of S11 to S13 in the flowchart of FIG. 6 will be described with reference to a flowchart of FIG. 7. As described above in S11 of FIG. 6, the CPU 31 of the learning server 1 accesses the device DB 50 at a predetermined date and time to check a new customer and a camera (a camera installed in a store of the new customer (including both the built-in camera 5 and the fixed camera 3), or a camera newly installed in a store of an existing customer) (S31). Then, if there is a new customer and a camera (in short, a new camera), the CPU 31 of the learning server 1 collects information of the above-described new camera (exactly speaking, including information of the signage 4 having the built-in camera 5 and information of the analysis box 2 connected to the fixed camera 3) from the device DB 50 (S32). Then, the CPU 31 of the learning server 1 compiles (a command of) a layout frame image collection request for the edge-side device (in short, the signage 4 corresponding to the new built-in camera 5 and the analysis box 2 connected to the new fixed camera 3) corresponding to the above-described new camera (S33), and transmits the compiled layout frame image collection request to the edge-side device corresponding to the above-described new camera using the communication unit 36 (S34).

When the edge-side device (the signage 4 and the analysis box 2) corresponding to the above-described new camera receives (the file of) the above-described layout frame image collection request from the learning server 1 (S35), the device extracts a frame image from a captured image captured by each camera (the fixed camera 3 or the signage 4) connected to the own-device at the date and time designated by the layout frame image collection request, and transmits a layout frame image of each camera to the learning server 1 if there is a layout frame image among the extracted frame images of respective cameras (YES in S37) (S38). Here, the date and time (the date and time of capturing the frame image of each camera) designated by the above-described layout frame image collection request is desirably a date and time of a plurality of time zones such as before opening, in the morning (after opening), in the daytime, and in the night. In this manner, by collecting the found layout frame image from the frame images captured in a plurality of time zones, a temporal bias (bias) can be removed from the collected layout frame image.

Upon receiving the layout frame image of each camera from the edge-side device (the signage 4 and the analysis box 2) corresponding to the above-described new camera (S39), the learning server 1 stores these layout frame images in a data DB 51 (S40).

When the layout frame images of all the new cameras are stored in the data DB 51, the CPU 31 of the learning server 1 extracts a feature vector (for example, a 2048-dimensional feature vector) from each of the layout frame images of the above-described new cameras stored in the data DB 51 using a most advanced AI model (for example, pretrained ResNet50) for extraction of image features stored in a reference model DB 52 (S41). For example, if the number of new cameras is 200, 200 feature vectors extracted from the respective layout frame images (200 images in total) of these cameras are extracted.

Next, the CPU 31 of the learning server 1 performs clustering (grouping) of the layout frame images of the above-described new cameras stored in the data DB 51 on the basis of the feature vectors of the extracted layout frame images using a most advanced machine learning algorithm for clustering stored in the reference model DB 52 (S42). Examples of the machine learning algorithm used for this clustering include t-distributed Stochastic Neighbor Embedding (t-SNE), Gaussian mixture model (GMM), K-Nearest Neighbor Algorithm (KNN), Principal Component Analysis (PCA), and the like.

Next, the CPU 31 of the learning server 1 selects a frame image (hereinafter, referred to as “representative frame image”) representing the layout frame image of each cluster from among the layout frame images belonging to each cluster (each group) grouped in the above-described S42, using a most advanced algorithm for selecting a representative frame image stored in the reference model DB 52 (S43). Here, the clustering (grouping) of the layout frame images in the above-described S42 is the same as grouping of the cameras (the built-in camera 5 and the fixed camera 3) that have captured the layout frame images. Therefore, the processing of selecting a representative frame image from among the layout frame images belonging to each group in the above-described S43 is substantially the same as the processing of selecting a representative camera in each grouped camera group. Examples of the algorithm for selecting a representative frame image include a method of selecting a layout frame image located at the center of each cluster as a representative frame image of each cluster, and a method of selecting a layout frame image having the largest number of neighboring layout frame images (the number of similar layout frame images) in each cluster as a representative frame image of each cluster.

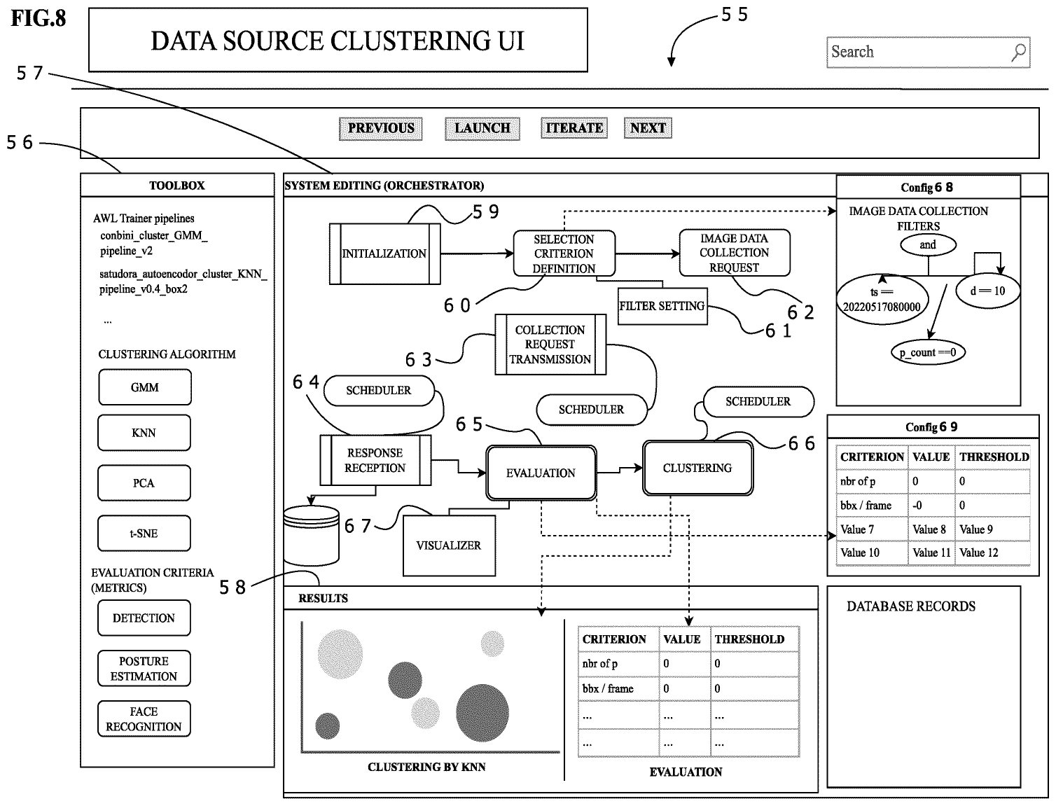

FIG. 8 shows a screen (data source clustering UI 55) for a user interface (UI) used by the system administrator on the learning server 1 side at the time of subsystem design for the clustering processing of the new data source (new camera). Note that, in the following description, “subsystem” means a software module group included in the dataset generation program 37 of the learning server 1. The data source clustering UI 55 includes a toolbox field 56, a system editing field 57, and a result field 58. In the toolbox field 56, a selection button of a machine learning algorithm (clustering algorithm) used for the clustering processing of the layout frame image described in S42 of FIG. 7 and a selection button of an evaluation criterion of the layout frame image received in S39 of FIG. 7 are displayed. In the example shown in FIG. 8, it is possible to select GMM, TNN, PCA, and t-SNE as the clustering algorithm, and it is possible to select “detection”, “posture estimation”, and “face recognition” as the evaluation criteria. However, in the data source clustering UI 55, since only the evaluation that there is no person is performed in an evaluation functional block (evaluation block) 65 in the system editing field 57, only the “detection” (of a person) is used among the above evaluation criteria.

In the system editing field 57 in FIG. 8, an initialization block 59, a selecting criterion definition block 60, a filter setting 61, an image data collection request block 62, a collection request transmission block 63, a response reception block 64, an evaluation block 65, a clustering block 66, and a visualization block 67 are used among functional blocks that can be used by the system administrator at the time of system design.

The clustering processing implemented by the above-described functional blocks of 59 to 66 are as described with reference to FIG. 7 and the like, and the following two points are important in a setting process (design) using the data source clustering UI 55. The first is how to set a method of setting a selecting criterion of image data (frame image) (a method of setting an image data collection filter). For example, the system administrator can set the image data collection filter (set the selecting criteria of the frame image) shown in a Config field 68 by clicking the filter setting 61 with the input device 35 (mouse). At the time of collection of layout frame images for clustering, selecting criteria of frame images are, for example, as shown in the Config field 68 of FIG. 8, (image capturing) start time=8:00 AM on May 17, 2022 (before opening), period=10 seconds, and the number of people=0. By employing such frame image selecting criteria, the learning server 1 collects at least one captured image (frame image) showing no person between 8:00 AM and 8:00:10 AM on May 17, 2022 from each of the new (plurality of) cameras. Note that, in practice, as described above, it is desirable to collect at least one layout frame image from the frame images of the respective cameras captured in a plurality of time zones.

Further, the second important point in the setting processing (design) using the data source clustering UI 55 is the selection processing of the clustering algorithm displayed in the toolbox field 56. A left side of the result field 58 in FIG. 8 shows a clustering result when the system administrator selects KNN from the clustering algorithms displayed in the toolbox field 56 using the input device 35. However, as described in S41 of FIG. 7, in a case where a 2048-dimensional feature vector is extracted from each of layout frame images of a new camera, in order to obtain a two-dimensional clustering result as shown on the left side of the result field 58 of FIG. 8, it is necessary to perform clustering by KNN after dimensionally reducing the 2048-dimensional feature vector described above to two dimensions.

A Config field 69 on the right side of the data source clustering UI 55 indicates a reference for evaluation of frame images (layout frame images) received from the edge-side device (the signage 4 and the analysis box 2), and the right side of the result field 58 indicates a result of evaluation of frame images received from the edge-side device. Since the frame image used in the clustering processing is a layout frame image showing no person, the number of people (“nbr of p”) appearing in the frame image is zero, and the number of bound boxes (“bbx/frame”) for each frame image (corresponding to detected person, face, or head) is zero in both the evaluation criteria shown in the Config field 69 and the evaluation result shown on the right side of the result field 58.

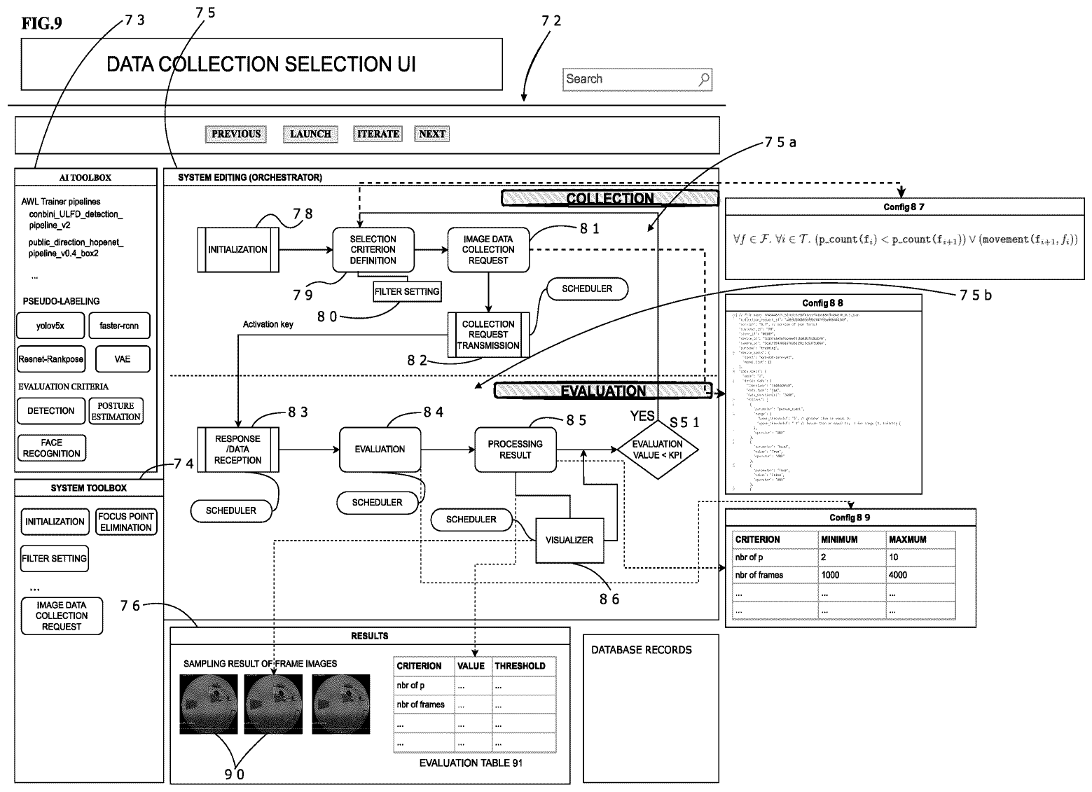

When the clustering processing is completed, the CPU 31 of the learning server 1 starts collecting frame images necessary for generating a learning dataset of the DNN model for predetermined inference processing as a target. Specifically, the CPU 31 of the learning server 1 first performs processing of collecting the minimum necessary number of frame images showing a person for the learning dataset on the basis of a mechanism edited by a data collection selection UI 72 shown in FIG. 9.

The above processing of collecting the minimum necessary number of frame images is performed as follows. First, in the data collection selection UI 72 shown in FIG. 9, the system administrator can set the image data collection filter (set the selecting criteria of the frame image) shown in a Config field 87 by, for example, clicking a filter setting 80 on the input device 35 (mouse). In the example of the Config field 87 shown in FIG. 9, the selecting criterion of the frame image is expressed by a mathematical expression. The system administrator can set the selecting criteria of the frame image (set the image data collection filter) by editing the program of the image data collection request described in the Config field 88 in addition to writing the formula in a Config field 87. When the setting operation of the selecting criteria of the frame images is completed (S14 in FIG. 6), the CPU 31 of the learning server 1 executes processing edited by the data collection selection UI 72 shown in FIG. 9, and collects frame images showing a person, having diversity, and meeting the selecting criteria set in the above S14 from the representative camera selected in the above S13 (in each camera group) until the collection of the minimum necessary number of frame images is completed (S15 and S16). In the example shown in FIG. 9, in order to collect frame images having diversity from the representative camera, the expression shown in the Config field 87 has contents of selecting a frame image with an increased number of people or a frame image with movement (movement of the position of a person or change in the posture of a person) as viewed from the previous frame image. Further, in the example shown in FIG. 9, the program of the image data collection request described in the Config field 88 has contents that the number of detected persons is five or more, the head is detected, and the thee is not detected.

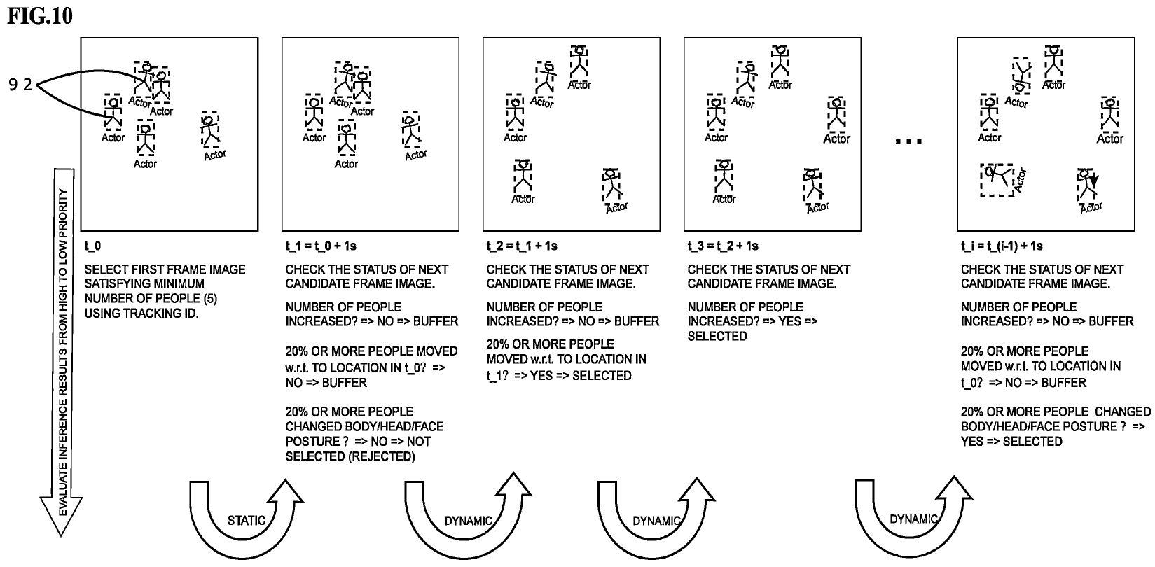

Next, an example of a frame image selection algorithm according to the selecting criteria set in S14 of FIG. 6 will be described with reference to FIG. 10. The CPU 31 of the learning server 1 gives a tracking ID to each person detected in the frame image captured by the above-described representative camera. More specifically the CPU 31 of the learning server 1 performs following processing (tracking processing) of the same customer (person 92) captured by the same representative camera by giving the same ID to the same customer across frames on the basis of, for example, the capturing time of each frame image captured by the same representative camera and the coordinate position of the person 92 (or the coordinate position and size of the person) detected by the learned DNS model for person detection for these frame images. Then, the CPU 31 of the learning server 1 selects a first frame image (in the example of FIG. 10, the frame image at the capturing time t_0) satisfying the criterion of the “minimum number of people” (five people in the examples of FIGS. 9 and 10) in the selecting criterion set by the data collection selection UI 72 from among the frame images captured by a certain representative camera (as a frame image to be collected) using the tracking ID (using tracking processing). In the example of FIG. 10, the following description will be given assuming that the frame rate of the frame image sent from each representative camera is 1 fps.

When the selection processing of the frame image at the capturing time t_0 is completed, the CPU 31 of the learning server 1 checks whether or not the frame image at the next capturing time t_1 (=t_0+1s) satisfies the selecting criterion set by the data collection selection UI 72. In this case (where the previous frame image is a frame image that satisfies the criterion of the “minimum number of people”), the frame image selecting criterion is that, in addition to the criterion of the “minimum number of people” (five people), any one of the following conditions is satisfied as viewed from the previous frame image: (1) the number of people has increased, (2) the position of the person has moved (exactly speaking, 20% or more people have moved from the position (location) in the previous frame image), and (3) the posture of the person has changed (exactly speaking, whether 20% or more people have changed their body/head/face posture as viewed from the previous frame image). The frame image at the capturing time t_1 does not satisfy any of the conditions (1) to (3), and thus the CPU 31 of the learning server 1 does not select this frame image at the capturing time t_1. On the other hand, the frame image at the capturing time t_2 (=t_1+1s) next to the capturing time t_1 does not satisfy the condition (1) but satisfies the condition (2), and thus the CPU 31 of the learning server 1 selects this frame image at the capturing time t_2. Further, the frame image at the capturing time t_3 (=t_2+1s) next to the capturing time t_2 satisfies the condition (1), and thus the CPU 31 of the learning server 1 selects the frame image at the capturing time t_3. Then, the frame image at the capturing time t_i (=t_(i−1)+1s) does not satisfy the conditions (1) and (2) but satisfies the condition (3), and thus the CPU 31 of the learning server 1 selects this frame image at the capturing time t_i.

Summarizing the selection processing of the frame images shown in FIG. 10 above, when the previous frame image is a frame image satisfying the criterion of the “minimum number of people”, the CPU 31 of the learning server 1 does not select a frame image having no change as viewed from the previous frame image (not satisfying any of the conditions (1) to (3) above), but it selects only a frame image having a change as viewed from the previous frame image (satisfying any one of the conditions (1) to (3) above). Thus, it is achieved that frame images showing a person and having diversity are efficiently collected from the representative camera.

Next, details of the data collection selection UI 72 shown in FIG. 9 will be described. The data collection selection UI 72 is a screen for a user interface (UI) to be used by the system administrator on the learning server 1 side at the time of designing a subsystem (software module group) for selecting and collecting frame images from the above-described representative camera. The data collection selection UI 72 includes an AI toolbox field 73, a system toolbox field 74, a system editing field 75, and a result field 76. Further, the system editing field 75 is divided into an upper collection area 75a and a lower evaluation area 75b. The system administrator arranges functional blocks related to selection and collection of frame images in the collection area 75a, arranges functional blocks related to evaluation of the collected frame images in the evaluation area 75b, and performs a setting operation of a selecting criterion for the Config field 87 and the Config field 88, thereby designing a subsystem for selection and collection of frame images from the above-described representative camera.

In the system editing field 75 in the data collection selection UI 72, among functional blocks that can be selected from the system toolbox field 74 by the system administrator, an initialization block 78, a selecting criterion definition block 79, a filter setting 80, an image data collection request block 81, a collection request transmission block 82, a response/data reception block 83, an evaluation block 84, a processing result block 85, and a visualizer 86 are used.

Among the above functional blocks, the functional blocks of 78 to 82 arranged in the collection area 75a, and the response/data reception block 83 arranged in the evaluation area 75b are used for the setting operation of the frame image selecting criteria by the system administrator in S14 of FIG. 6, and the frame image collection processing from each representative camera in S15. In addition, the evaluation block 84 arranged in the evaluation area 75b performs inference processing necessary for evaluation of the frame image received from each representative camera by the response/data reception block 83. In this data collection selection UI 72 (that is, at the stage of collecting the minimum necessary number of frame images), the inference processing performed by the evaluation block 84 is the same type of inference processing as the human detection processing in each frame image and the inference processing performed by the DNN model for predetermined inference processing as a target (the same type of inference processing as the inference processing performed by the learned DNN model for inference processing of the edge-side device). However, in the inference processing performed by the evaluation block 84, a learned DNN model for inference processing that is heavier than the learned DNN model for inference processing of the edge-side device and has high accuracy is used. Further, the evaluation block 84 is used to set evaluation criteria for the frame images collected from the respective representative cameras. For example, by clicking the evaluation block 84 on the input device 35, the system administrator can perform setting input of the evaluation criteria of the frame image shown in a Config field 89. In the Config field 89, a setting input of the (evaluation) reference and its range (minimum value and maximum value regarded as normal values) can be performed.

In addition, the processing result block 85 outputs the result of the inference processing for the evaluation performed in the above-described evaluation block 84 to a determination block of an evaluation value in S51 and an evaluation table 91 on the right side of the result field 76.

In the determination block of S51 of FIG. 9, the CPU 31 of the learning server 1 determines whether or not the evaluation value for the frame image received from each representative camera by the response/data reception block 83 has reached a KPI (target). Specifically, in the system designed by the data collection selection UI 72, since the purpose is to collect the minimum number of frame images showing a person necessary for the learning dataset, the KPI in S51 is the following three.

A first KPI (target) is to collect a predetermined number or more (minimum necessary number) of frame images. For example, it is to collect 1000 frame images from each representative camera. Further, a second KPI (target) is that each frame image includes a person. For example, the processing result block 85 performs human detection processing on all the frame images received from the respective representative cameras by the response/data reception block 83, and as a result, a person is detected in all the frame images. A third KPI (target) is that, as a result of the evaluation block 84 performing the same type of inference processing as the learned DNN model for inference processing of the edge-side device on the frame images received from the respective representative cameras by the response/data reception block 83, all the frame images received from the respective representative cameras described above have content included in any class. Specifically for example, in a case where the learned DNN model for inference processing of the edge-side device (the DNN model for predetermined inference processing as a target) is a learned DNN model for head/face detection, the third KPI is that, as a result of the evaluation block 84 performing head/face detection processing on all the frame images received from the respective representative cameras, one or more (that is, “head” or “face”) included in any class that can be given by the learned DNN model for head/face detection are detected in all the frame images received from the respective representative cameras described above. The purpose of providing the third KPI is to reduce imbalance of the class of the object (exactly speaking, a person) included in the frame image in the learning dataset. Such class imbalance reduces inference accuracy for minority classes.

In the determination of S51, when the CPU 31 of the learning server 1 determines that the evaluation value for the frame image received from the respective representative cameras by the response/data reception block 83 does not reach the KPI (target) (when it is determined that there is an unachieved KPI among the above three KPIs) (YES in S51), the system administrator adds or changes the selecting criteria of the frame image in the Config field 87 and the Config field 88 using the input device 35 as necessary Then, the system administrator instructs the CPU 31 of the learning server 1 by the input device 35 to repeat the processing of the selecting criterion definition block 79, the image data collection request block 81, the collection request transmission block 82, the response/data reception block 83, the evaluation block 84, and the processing result block 85 until the evaluation value reaches the KPI (target) (until all of the above three KPIs are achieved).

On the right side of the result field 76 in the data collection selection UI 72, the evaluation table 91 indicating how the evaluation result of the frame image received from each representative camera is with respect to the evaluation criteria of the frame image input in the Config field 89 is displayed, The evaluation result displayed in the evaluation table 91 is an evaluation result obtained from the result of the inference processing executed by the evaluation block 84 except for the number of frame images (“nbr of frames”) received from each representative camera.

A plurality of sample images 90 obtained by the visualizer 86 is displayed on the left side of the result field 76 in the data collection selection UI 72. These sample images 90 are frame images sampled from the frame images received from the respective representative cameras, and results of the inference processing executed by the evaluation block 84 (for example, a bounding box of a person or a head) are overlapped with these sample images 90 for visualization of the processing results. That is, the visualizer 86 is a visualization tool for displaying the frame image 90 with the correct answer label as a sample, and is a tool to be used by the system administrator to confirm what is currently occurring, particularly, in a case where the evaluation value for the frame image received from each representative camera does not reach the KPI (target), or the like.

When the evaluation value for the frame image received from the representative camera reaches the KPI (target) in the determination of S51 of FIG. 9, that is, when the collection of the minimum necessary number of frame images is completed in S16 of the flowchart of FIG. 6 (YES in S16), the CPU 31 of the learning server 1 performs pseudo-labeling processing for evaluation (“inference processing for evaluation” in the claims) on each of the frame images collected from each representative camera (S17). Then, the quality of the dataset including the frame images collected from each representative camera described above is evaluated on the basis of the result of the pseudo-labeling processing for the frame images (S18). More specifically, on the basis of the result of the pseudo-labeling processing on the frame image collected from each representative camera, it is evaluated whether or not the dataset including the frame image collected from each representative camera described above is suitable as a learning dataset for fine tuning of the DNN model for predetermined inference processing as a target.

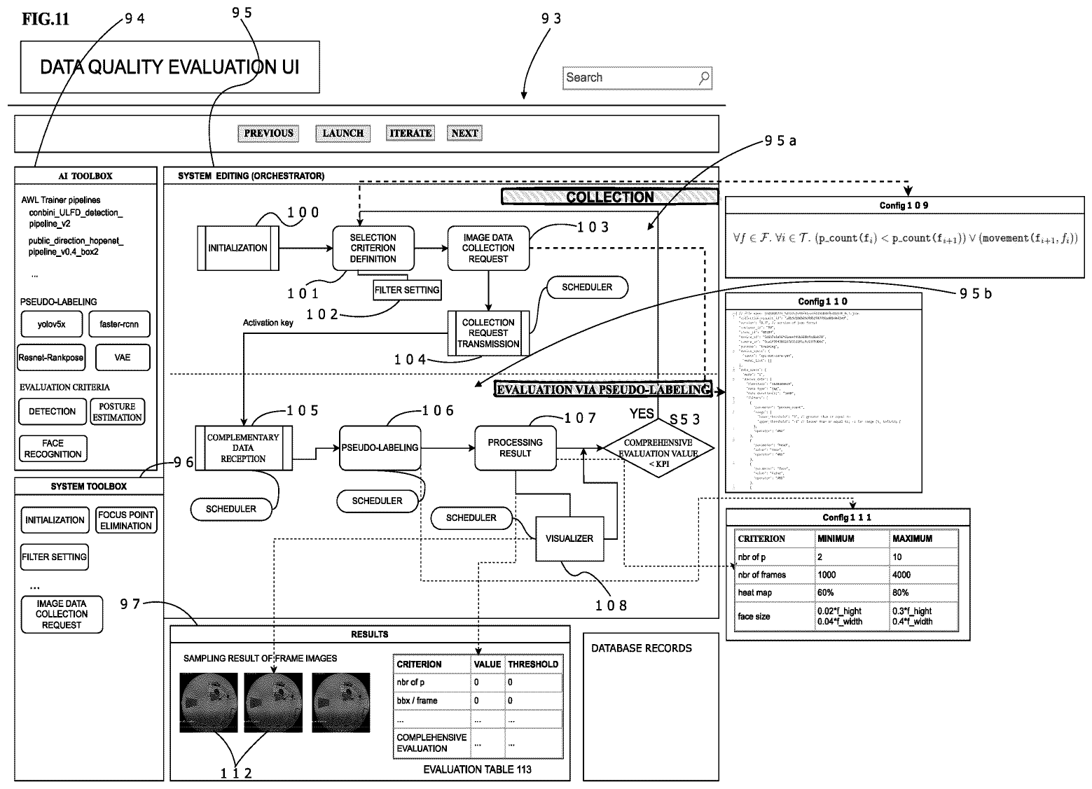

The evaluation of the quality of the dataset based on the result of the above pseudo-labeling processing is as follows. That is, the result of the pseudo-labeling processing on the frame images included in the dataset teaches whether or not the dataset has any bias. For example, in a case where the DNN model for predetermined inference processing as a target is a DNN model for face detection or a DNN model for inference processing on an image of a face detected in the DNN model for face detection (for example, a DNN model for inference processing such as estimation processing of gender and age, face vector extraction processing, and identification processing of a person), when 80% or more of the frame images included in the dataset are frame images in which the size of the face shown is smaller than the predetermined size, this dataset has a bias that the size of the face shown in the frame image is small, and thus is not suitable as a learning dataset for fine tuning of the DNN model for inference processing as a target. In order to evaluate the quality of the dataset as described above, the CPU 31 of the learning server 1 performs face detection processing using the learned DNN model for face detection as pseudo-labeling processing on each of the frame images collected from each representative camera to obtain the size of the face bounding box. Then, it is determined whether or not the size of the face bounding box obtained by the face detection processing (pseudo-labeling processing) for each frame image falls within the range of normal values (range of minimum value to maximum value) of the face size shown in a Config field 111 of FIG. 11. As a result of this determination, when there are a large number of frame images of which the face size is within the range of normal values among the frame images included in the dataset, a “comprehensive evaluation value” (of the quality of the dataset) in the determination of S53 of FIG. 11 becomes high, and conversely, when there are a small number of frame images of which the face size is within the range of normal values, the “comprehensive evaluation value” becomes low.

In addition, the pseudo-labeling processing is performed on the frame image included in the dataset using the current version of the learned DNN model for the DNN model for predetermined inference processing as a target, and a result of the pseudo-labeling processing by the current version of the learned DNN model and a result of the inference processing by the learned DNN model for inference processing that is heavier than the current version of the learned DNN model and has high accuracy are matched, and if the following probability of being determined as False Positive is high, this dataset has a bias of including many frame images that are highly likely to be determined as False Positive, and thus is not suitable for the learning dataset for fine tuning of the inference processing DNN model as a target. Note that the determination of False Positive is made in a case where the result of the inference processing by the above-described learned DNN model for inference processing with high accuracy is negative although the result of the pseudo-labeling processing (inference processing) by the current version of the learned DNN model is positive. For example, in a case where the DNN model for inference processing as a target is a DNN model for face detection, for a certain frame image, as a result of the pseudo-labeling processing (inference processing) by the current version of the learned DNN model for face detection, a correct answer label of a face is assigned, but if a face is not detected (in the above frame image) as a result of inference processing by the learned DNN model for face detection that is heavier than the current version of the learned DNN model for face detection and has high accuracy, it is determined that it is False Positive. The above determination is made for each frame image included in the dataset, and as a result, when the probability of being determined as False Positive is high, the “comprehensive evaluation value” (of the quality of the dataset) in the determination of S53 of FIG. 11 becomes low, and conversely, when the probability of being determined as False Positive is low, the above “comprehensive evaluation value” becomes high.

Furthermore, in a case where the DNN model for predetermined inference processing as a target is a DNN model for estimating the gender of a person, in a case where 80% or more of the frame images included in the dataset are frame images in which only women appear, this dataset has a bias that there are many women in people appearing in the frame images, and thus it is not suitable as a learning dataset for fine tuning of the DNN model for estimating the gender of the person as a target. In order to evaluate the quality of the dataset as described above, the CPU 31 of the learning server 1 performs, as pseudo-labeling processing, gender estimation processing using a learned DNN model for estimating the gender of a person on each of frame images collected from each representative camera, and gives a correct answer label of “male” or “female” to each frame image. Then, it is determined whether or not the ratio of “male” or the ratio of “female” in the entire correct answer labels falls within a range of normal values. As a result of this determination, if the ratio of “male” or the ratio of “female” falls within the range of normal values, the “comprehensive evaluation value” (of the quality of the dataset) the determination of S53 of FIG. 11 becomes high, and conversely, if the ratio does not fall within the range of normal values, the “comprehensive evaluation value” becomes low. Note that the above-described learned DNN model for gender estimation used in the pseudo-labeling processing is desirably a learned DNN model for inference processing that is heavier than the learned DNN model for gender estimation used in the edge-side device and has high accuracy.

Among the evaluations of the quality of the dataset based on the results of the above pseudo-labeling processing, the simplest one is the following example. In a case where the DNN model for predetermined inference processing as a target is a DNN model for detecting a person, a face, or a head or a DNN model for recognizing an object for a person or a face, it is preferable that the number of people (“nbr of p”) appearing in the frame image is within a certain range (for example, 2 to 10 people) as shown in the Config field 111 of FIG. 11. In such a case, the CPU 31 of the learning server 1 performs person detection processing using the learned DNN model for detecting a person as pseudo-labeling processing on each frame image collected from each representative camera, and obtains the number of persons appearing in each frame image. Then, among the frame images included in the dataset, the ratio of frame images in which the number of people appearing in the frame image falls within the range of the number of people shown in the Config field 111 of FIG. 11 is obtained. As a result, when the ratio of the frame images in which the number of people appearing in the frame images among the frame images included in the dataset is within the range of the number of people shown in the Config field 111 of FIG. 11 is high, the “comprehensive evaluation value” (of the quality of the dataset) in the determination of S53 of FIG. 11 becomes high, and conversely, when the ratio of the frame images included in the range of the number of people is low, the “comprehensive evaluation value” becomes low.

As described above, since the result of the pseudo-labeling processing for the frame images included in the dataset teaches whether or not this dataset has any bias, as described above, by giving a correct answer label to the frame images included in the dataset using any pseudo-labeling model for person detection, face detection, head detection, posture estimation, or the like, it is determined whether or not the current dataset falls within the range (range of minimum value to maximum value) of normal values of each evaluation criterion shown in the Config field 111 in FIG. 11, and the “comprehensive evaluation value” (of the quality of the dataset) can be obtained from a determination result thereof.

If it is determined that the “comprehensive evaluation value” (of the quality of the dataset) does not reach the KPI (target) as a result of the evaluation of the quality of the dataset in the above S18 (YES in S19), the system administrator adds or changes the selecting criteria of the frame image in a Config field 109 and a Config field 110 of FIG. 11 using the input device 35, and then instructs the CPU 31 of the learning server 1 to improve the dataset (add or delete the frame image) according to the evaluation result of the quality of the dataset by the input device 35, if necessary. Thus, the CPU 31 of the learning server 1 repeats the processing of S17 to S20 until the comprehensive evaluation value reaches the KPI (target), and collects a frame image showing a person from each representative camera or deletes an extra frame image (S20), thereby improving the quality of the dataset. For example, in a case where the number of frame images (“nbr of frames”) received from each representative camera does not reach the predetermined number, the CPU 31 of the learning server 1 collects frame images showing a person from each representative camera, and complements the dataset with these frame images. In addition, as a result of the pseudo-labeling processing in S17, in a case where there is a bias (there is class imbalance) in the label (class) given to each frame image in the dataset, the CPU 31 of the learning server 1 removes (deletes) a part of the frame images belonging to the majority classes from the dataset, thereby equilibrating (balancing) the classes in (the frame images of) the dataset.

Next, details of a data quality evaluation UI 93 shown in FIG. 11 will be described. The data quality evaluation UI 93 is a screen for a user interface (UI) to be used by the system administrator on the learning server 1 side at the time of designing a subsystem for evaluating the quality of a dataset including frame images collected from each representative camera and adding frame image data to the dataset. The data quality evaluation UI 93 includes an AI toolbox field 94, a system toolbox field 96, a system editing field 95, and a result field 97. Further, the system editing field 95 is divided into an upper collection area 95a and a lower pseudo-labeling evaluation area 95b. The system administrator arranges functional blocks related to the selection and collection of frame images in the collection area 95a, arranges functional blocks related to the evaluation (via pseudo-labeling) of the quality of the dataset including the collected frame images in the pseudo-labeling evaluation area 95b, and performs the setting operation of addition and change of the selecting criteria to the Config field 110 and the Config field 111 described above, thereby designing a subsystem for performing the above-described evaluation of the quality of the dataset and complementing the dataset with the frame image data.

In the system editing field 95 in the data quality evaluation UI 93, among functional blocks that can be selected from the system toolbox field 96 by the system administrator, an initialization block 100, a selecting criterion definition block 101, a filter setting 102, an image data collection request block 103, a collection request transmission block 104, a complementary data reception block 105, a pseudo-labeling block 106, a processing result block 107, and a visualizer 108 are used.

Among the above functional blocks, the functional blocks of 100 to 104 arranged in the collection area 95a and the complementary data reception block 105 arranged in the pseudo-labeling evaluation area 95b are used for addition/change operation of the frame image selecting criteria by the system administrator and frame image collection (complement) processing from each representative camera described in the description of S20 of FIG. 6. Further, the pseudo-labeling block 106 arranged in the pseudo-labeling evaluation area 95b corresponds to the evaluation inference circuitry 46 in FIG. 5, and performs the pseudo-labeling process for evaluation (“inference processing for evaluation” in the claims) on each of frame images received from each representative camera (that is, the processing of S17 in FIG. 6 is performed). Further, the pseudo-labeling block 106 is used to set evaluation criteria for the frame images collected from each representative camera. For example, the system administrator can perform setting input of the evaluation criteria of the quality of the frame image (dataset) shown in the Config field 111 by clicking the pseudo-labeling block 106 on the input device 35. In the Config field 111, it is possible to perform setting input of each evaluation criterion of the quality of the frame image (dataset) and its normal range (minimum value and maximum value regarded as normal values).

In addition, the processing result block 107 outputs a result of the pseudo-labeling processing for evaluation performed by the pseudo-labeling block 106. The result of the pseudo-labeling processing for evaluation is used for the determination processing in the determination block of the comprehensive evaluation value in S53 and the output of the value corresponding to each criterion in an evaluation table 113 on the right side of the result field 97.

In the determination block of S53 of FIG. 11, the CPU 31 of the learning server 1 determines whether or not the comprehensive evaluation value of the quality of the dataset via the pseudo-labeling processing has reached the KPI (target).

In the determination of S53, when the CPU 31 of the learning server 1 determines that the comprehensive evaluation value of the quality of the dataset does not reach the KPI (target) (YES in S53), the system administrator adds or changes the frame image selecting criteria in the Config field 109 and

the Config field 110 using the input device 35 as necessary. Then, in a case where the number of frame images (“nbr of frames”) received from each representative camera does not reach a predetermined number as a result of the evaluation of the quality of the dataset, the system administrator instructs, by the input device 35, the CPU 31 of the learning server 1 to repeat the processing of the image data collection request block 103, the collection request transmission block 104, the complementary data reception block 105, the pseudo-labeling block 106, the processing result block 107, and the determination block of the comprehensive evaluation value of S53 until the comprehensive evaluation value reaches the KPI (target). However, as a result of the pseudo-labeling processing, in a case where there is a bias (class imbalance) in the label (class) given to each frame image in the dataset, the CPU 31 of the learning server 1 removes (deletes) a part of the frame images belonging to the majority of classes from the dataset, thereby equilibrating (balancing) the classes in (the frame images of) the dataset. In this case, the CPU 31 of the learning server 1 performs the process of deleting a part of the frame images belonging to the majority classes, and then repeats the determination process of S53 again.

Note that, as can be seen from the flow of the processing described in FIG. 6, the processing on the data quality evaluation UI 93 side performed immediately after the collection of the minimum necessary number of frame images defined in the data collection selection UI 72 is the processing of the pseudo-labeling block 106 and the processing result block 107 and the determination processing of the comprehensive evaluation value by the determination block S53. Then, in the first determination in S53, in a case where the CPU 31 of the learning server 1 determines that the comprehensive evaluation value of the quality of the dataset has reached the KPI, the processing of the blocks of 101 to 105 described above is never performed.

On the right side of the result field 97 in the data quality evaluation UI 93, the evaluation table 113 indicating how the evaluation result for the dataset including the frame image received from each representative camera is with respect to the evaluation criteria of the dataset input in the Config field 111 is displayed. The evaluation result displayed in the evaluation table 113 is an evaluation result obtained from the result of the pseudo-labeling processing for evaluation executed by the pseudo-labeling block 106.

A plurality of sample images 112 obtained by the visualizer 108 is displayed on the left side of the result field 97 in the data quality evaluation UI 93. These sample images 112 are frame images sampled from the frame images received from each representative camera, and results of the pseudo-labeling processing for evaluation performed by the pseudo-labeling block 106 (for example, the bounding box of a person or a head) are overlapped on these sample images 112 for visualization of the processing results. That is, the visualizer 108 is a visualization tool for displaying, as a sample, the frame image 112 with the correct answer label obtained by the pseudo-labeling processing, and is a tool to be used by the system administrator to confirm what is going on particularly in a case where the comprehensive evaluation value of the quality of the dataset does not reach the KPI (target), or the like.

In the determination of S53 of FIG. 11 (corresponding to the determination of S19 of FIG. 6), when the comprehensive evaluation value of the quality of the dataset reaches the KPI (target), that is, when the generation of the dataset, which is considered to be suitable as the learning dataset for fine tuning of the DNN model for inference processing as a target, is completed, the CPU 31 of the learning server 1 performs fine tuning of the original learned DNN model for inference processing using this dataset (dataset including frame images collected from the representative camera) as the learning dataset (S21 of FIG. 6). Here, the original learned DNN model for inference processing may be the current version of the learned DNN model for inference processing of the edge-side device (DNN model for predetermined inference processing as a target), or may be a general-purpose learned DNN model in which machine learning is performed on a public (usable by a general person) learning dataset.

When the fine tuning of the learned DNN model in S21 is completed, the CPU 31 of the learning server 1 evaluates the learned DNN model after the tine tuning (S22). Specifically, the CPU 31 of the learning server 1 performs inference processing on the frame image included in an unknown test dataset separately collected in a procedure similar to the procedure shown in the data quality evaluation UI 93 using both the learned DNN model before the fine tuning and the learned DNN model after the fine tuning, and compares the accuracy of the inference processing by the learned DNN models before and after the fine tuning. As a result, when the accuracy of the inference processing by the learned DNN model after the fine tuning is improved by a predetermined value or more from the accuracy of the inference processing by the learned DNN model before the fine tuning (for example, a case where an F1 score of the learned DNN model after the fine tuning is improved by 5% or more as compared with the F1 score of the learned DNN model before the fine tuning), the CPU 31 of the learning server 1 determines that the evaluation value (F1 score) of the processing result by the learned DNN model after the fine tuning is equal to or more than the KPI (has reached the target). In this case (NO in S23), the CPU 31 of the learning server 1 considers that the generalization of the DNN model for inference processing as a target has been completed (S25), and distributes the above-described learned DNN model after the fine tuning to the edge-side device.

The test dataset is a dataset collected by a procedure similar to the procedure shown in the data quality evaluation UI 93, and is a dataset obtained by repeating the processing of the image data collection request block 103, the collection request transmission block 104, the complementary data reception block 105, the pseudo-labeling block 106, the processing result block 107, and the determination block of the comprehensive evaluation value of S53 until the comprehensive evaluation value of the quality of the dataset reaches the KPI (target) in the determination of S53 of the data quality evaluation UI 93. Note that, at the time of generating the test dataset, the items themselves of the evaluation criteria of the dataset shown in the Config field 111 of FIG. 11 are the same as those at the time of generating the above-described learning dataset, but the values of the respective items of the evaluation criteria are different. For example, among the evaluation criteria of the dataset, the number of frame images (“nbr of frames”) is 1000 or more for each camera at the time of generating the learning dataset, but 100 or more for each camera is sufficient at the time of generating the test dataset,

In addition, the frame image constituting the test dataset is not necessarily a frame image acquired from each representative camera as in the case of generating the learning dataset, and may be a frame image acquired from a camera other than the representative camera in each camera group, By using a dataset including frame images acquired from a camera other than the above-described representative camera as a test dataset, it is possible to check whether or not the learned DNN model after the fine tuning is spatially generalized. Here, “generalization” of the learned DNN model means that the learned DNN model can output a correct result for unknown input data (in this case, an unknown frame image). Furthermore, the “learned DNN model is spatially generalized” in this case means that, even in a case where a frame image acquired from a camera different from the representative camera and not included in the learning dataset is input to the learned DNN model, the learned DNN model can output a correct result as in a case where a frame image acquired from the representative camera is input.

In addition, the frame image constituting the above test dataset may be a frame image captured by each of the representative cameras described above at a date and time different from the time of acquiring the frame image for the learning dataset. By using the dataset including the frame image captured by the representative camera at the date and time different from the time of capturing the frame image for the learning dataset as the test dataset, it is possible to check whether or not the learned DNN model after the fine tuning is temporally generalized. The “learned DNN model is temporally generalized” in this case means that, even when a frame image captured at a date and time different from the time of capturing the frame image for the learning dataset is input to the learned DNN model, the learned DNN model can output a correct result as in a case where the frame image for the learning dataset is input.

On the other hand, when the accuracy (F1 score) of the inference processing by the learned DNN model after the fine tuning is not improved by a predetermined value or more from the accuracy (F1 score) of the inference processing by the learned. DNN model before the fine tuning, the CPU 31 of the learning server 1 determines that the evaluation value of the processing result by the learned. DNN model after the fine tuning has not reached the KPI (target) (YES in S23). As described above, in a case where the accuracy of the inference processing by the learned DNN model after the fine tuning is not improved by the predetermined value or more from the accuracy of the inference processing by the learned DNN model before the fine tuning (in particular, in a case where the accuracy of the inference processing by the learned DNN model after the fine tuning is lower than the accuracy of the inference processing by the learned DNN model before the fine tuning), it means that the learned DNN model after the fine tuning is in a state of being over-adapted to the bias of the learning dataset (over-learned state) and is not generalized (made general). In short, it means that the learned DNN model after the fine tuning has learned the data of the learning dataset but has not been adapted to the data included in the unknown test dataset.

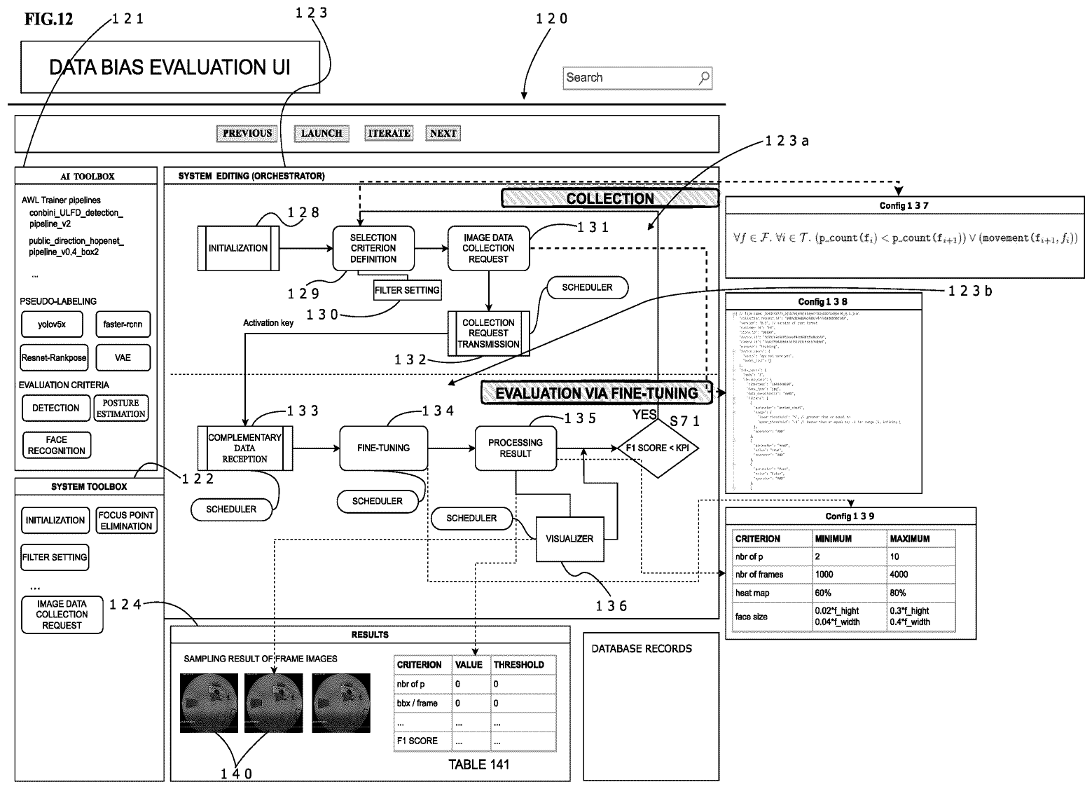

In a case of YES in the above S23 (when the evaluation value (F1 score) of the processing result by the learned DNN model after the fine tuning has not reached KPI (target)), the system administrator adds or changes the selecting criteria of the frame image in the Config field 137 and the Config field 138 of FIG. 12 using the input device 35 if necessary, and then instructs the CPU 31 of the learning server 1 to collect (complement) the frame image showing a person from each representative camera by the input device 35. Thus, the processing of S21 to S24 is repeated until the evaluation value (F1 score) reaches the KPI (target), and the complement (S24) of the frame image showing a person from each representative camera appears is repeated. The reason for this is that the evaluation value (accuracy) of the processing result by the learned DNN model after the fine tuning does not reach the KPI (target) means that the size of the learning dataset used for the fine tuning is not sufficiently large, and it is necessary to complement the learning dataset with more frame images in other words, it is necessary to add more frame images to the learning dataset). Note that, when the complement processing of the frame images shown in the above S24 is finished, the CPU 31 of the learning server 1 returns to the processing of the above S17 again, and performs the pseudo-labeling processing (S17) on the frame image complemented in S24 and evaluation processing (S18) of the quality of the dataset based on the result of the pseudo-labeling processing. Then, in a case where a bias occurs (class imbalance occurs) in the label (class) given to each frame image in the dataset as a result of the complement processing of the frame images to the learning dataset shown in the above-described S24, the CPU 31 of the learning server 1 removes (deletes) a part of the frame images belonging to the majority class from the dataset in the above-described process of S20, thereby equilibrating (balancing) the class in (the frame images of) the dataset. However, although not very preferable, when the complement processing of the frame images shown in the above-described S24 is completed, the CPU 31 of the learning server 1 may return to the processing of S21 instead of the processing of S17.

Next, a data bias evaluation UI 120 shown in FIG. 12 will be described. The data bias evaluation UI 120 is a screen for a user interface (UI) to be used at the time of designing a subsystem for evaluating through the fine tuning of a dataset for which it is determined in the above-described S19 that the comprehensive evaluation value of the quality has reached the KPI and complementing (adding) this dataset with the frame image data. Using the subsystem designed using the data quality evaluation UI 93 shown in FIG. 11, it is possible to generate a dataset which is considered to be suitable for the learning dataset for fine tuning of the DNN model for predetermined inference processing as a target, but when fine tuning of the original learned DNN model for inference processing is performed using this dataset, it may actually occur that the accuracy of the inference processing by the learned DNN model after the fine tuning is lower than the accuracy of the inference processing by the (original) learned DNN model before the fine tuning, or that the accuracy is hardly improved. Even in such a case, the data bias evaluation UI 120 shown in FIG. 12 is a screen for a user interface to be used at the time of designing a subsystem for complementing the dataset with necessary frame image data and completing generation of a learning dataset for fine tuning of the DNN model for predetermined inference processing as a target.

The data bias evaluation UI 120 includes an AI toolbox field 121, a system toolbox field 122, a system editing field 123, and a result field 124. Further, the system editing field 123 is divided into an upper collection area 123a and a lower fine tuning evaluation area 123b. The system administrator arranges functional blocks related to selection and collection of frame images in the collection area 123a, arranges functional blocks related to evaluation via fine tuning of a dataset including the collected frame images in the fine tuning evaluation area 123b, and performs setting operation of addition and change of selecting criteria to the Config field 137 and the Config field 138, thereby designing a subsystem for evaluating the dataset via the fine tuning and complementing the dataset with the frame image data.

In the system editing field 123 in the data bias evaluation UI 120, among functional blocks that can be selected from the system toolbox field 122 by the system administrator, an initialization block 128, a selecting criterion definition block 129, a filter setting 130, an image data collection request block 131, a collection request transmission block 132, a complementary data reception block 133, a fine tuning block 134, a processing result block 135, and a visualizer 136 are used.

Among the functional blocks described above, the functional blocks of 128 to 132 arranged in the collection area 123a and the complementary data reception block 133 arranged in the fine timing evaluation area 123b are used for addition/change operation of the frame image selecting criteria by the system administrator and the frame image collection (complement) processing from each representative camera described in the description of S24 of FIG. 6. In addition, the fine tuning block 134 arranged in the fine tuning evaluation area 123b performs fine tuning processing (that is, the process of S21 in FIG. 6) of the original learned DNN model for inference processing using a dataset including frame images collected from each representative camera as the learning dataset. The fine tuning block 134 corresponds to the relearning circuitry 49 in FIG. 5.

In addition, the processing result block 135 outputs the result of the inference processing by the learned DNN model after the fine tuning performed in the fine tuning block 134. The result of the inference processing by the learned DNN model after the fine tuning is used for the determination processing in the F1 score determination block in S71 and output of the F1 score in Table 141 on the right side of the result field 124.

In the determination block of S71 of FIG. 12, the CPU 31 of the learning server 1 determines whether or not the accuracy of the inference processing by the learned DNN model after the fine tuning has reached KPI (target) (specifically whether or not the accuracy (F1 score) of the inference processing by the learned DNN model after the fine tuning is improved by a predetermined value or more as compared with the accuracy of the inference processing by the learned DNN model before the fine tuning).

In the determination of S71, when the CPU 31 of the learning server 1 determines that the accuracy of the inference processing based on the learned. DNN model after the fine tuning has not reached the KPI (target) (YES in S71), the system administrator adds or changes the selecting criteria of the frame image in the Config field 137 and the Config field 138 using the input device 35 as necessary. Then, the system administrator instructs, by the input device 35, the CPU 31 of the learning server 1 to repeat the processing of the image data collection request block 131, the collection request transmission block 132, the complementary data reception block 133, the fine tuning block 134, the processing result block 135, and the determination block of the F1 score (accuracy) of S71 until the accuracy of the inference processing by the learned DNN model after the fine tuning reaches the KPI (target).

Note that, as can be seen from the flow of the processing described in FIG. 6, the processing on the data bias evaluation UI 120 side, which is performed immediately after the generation of the dataset considered to be suitable for the learning dataset for fine tuning of the DNN model for predetermined inference processing as a target is completed (comprehensive evaluation value of the quality of the dataset reaches the KPI) in the subsystem designed (defined) by the data quality evaluation UT 93, is the processing of the fine tuning block 134 and the processing result block 135 and the determination processing of the F1 score (accuracy) by the determination block S71. Then, in the first determination in S71, in a case where the CPU 31 of the learning server 1 determines that the accuracy of the inference processing by the learned DNN model after the fine tuning has reached the KPI (target), the processing of the blocks 129 to 133 is never performed.

On the right side of the result field 124 in the data bias evaluation UI 120, a table 141 indicating how is the result (including the F1 score) of the inference processing by the learned DNN model after the fine tuning performed in the fine tuning block 134 is displayed.

A plurality of sample images 140 obtained by the visualizer 136 is displayed on the left side of the result field 124 in the data bias evaluation UI 120. These sample images 140 are frame images obtained by sampling frame images included in the above-described unknown test dataset used for a test of inference processing by the learned DNN model after the fine tuning, and results (for example, a bounding box of a person or a head) of the inference processing by the learned DNN model after the fine tuning are overlapped with these sample images 140 for visualization of processing results. In other words, the visualizer 134 is a visualization tool for displaying, as a sample, the frame image 140 with the correct answer label obtained by the inference processing by the learned DNN model after the fine tuning, and is particularly a tool to be used by the system administrator to confirm what is happening now in a case where the accuracy of the inference processing by the learned DNN model after the fine tuning does not reach KPI (target), or the like.

It is possible to determine whether or not the accuracy (F1 score) of the inference processing by the learned DNN model after the fine tuning has reached the KPI (target), for example, by comparing the result of the inference processing by the learned DNN model after the fine tuning with the result of the inference processing by the learned DNN model for inference processing of the same type that is heavier than the DNN model for inference processing and has higher accuracy. As described above, basically, the CPU 31 of the learning server 1 automatically determines whether or not the accuracy (F1 score) of the inference processing by the learned DNN model after the fine tuning reaches the KPI (target), but the system administrator may visually determine whether or not the accuracy (F1 score) reaches the KPI (target) by displaying a plurality of sample images 140 one after another using the above-described visualizer 136.

The subsystem designed using the data bias evaluation UI 120 shown in FIG. 12 determines whether or not the data of the learning dataset including the frame images collected from the data source (edge-side device) supports generalization of the DNN model for inference processing as a target. That is, it is determined whether or not the learned DNN model for inference processing fine-tuned using the learning dataset including the frame images collected at the present time is temporally and spatially generalized. For example, the learned DNN model for inference processing learned (trained) on the basis of the data (learning dataset) collected from (the edge-side device of) the store A may not be generalized to the store B (as in a case where the frame image of the store A is input, the correct result cannot be output even when the frame image of the store B is input) even if the store A and the store B belong to the same group (the same franchise chain or the like). Alternatively, the learned DNN model for inference processing that has been learned (trained) on the basis of data (learning dataset) collected in the summer may have reduced accuracy in snowy winter in Hokkaido due to a change in customer environment due to the influence of snow. In addition, the attribute of the customer who visits the store considerably changes, and for example, the age configuration in the population may change as compared with the time of collecting the data of the learning dataset. We introduce the concept of “bias across (attributes of) space/time”. This bias across space/time can be automatically found on the basis of the accuracy of the result of inference processing with the DNN model for inference processing trained on the current learning dataset with respect to the frame image included in the unknown test dataset.

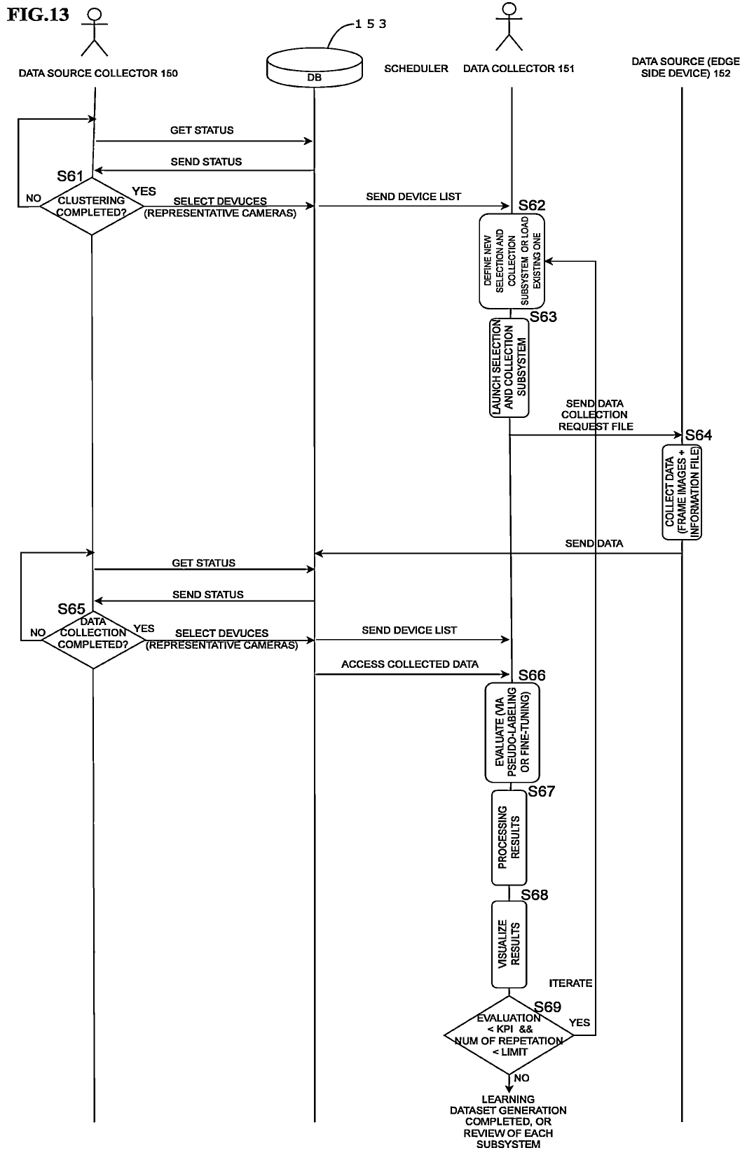

Next, a flow of collection of (frame image) data in the dataset generation system 10 will be described with reference to FIG. 13. The data source collector module 150 and the data collector module 151 in FIG. 13 are programs included in the dataset generation program 37 shown in FIG. 4. When the clustering (grouping) of the cameras described in S12 of FIG. 6 is completed (YES in S61 of FIG. 13), the data source collector module 150 of the learning server 1 selects representative cameras in each of the grouped groups, and transmits a list (device list) of these representative cameras to the data collector module 151 side. Thereafter, the system administrator on the learning server 1 side instructs the CPU 31 of the learning server 1 to define (design) a selection and collection subsystem (hereinafter abbreviated as “selection and collection subsystem”) of a frame image from the above-described representative camera using the input device 35 and the data collection selection UI 72 in FIG. 9 or to load an existing selection and collection subsystem that has already been defined using the input device 35 ( ). Then, the system administrator activates the selection and collection subsystem using the input device 35 (S63).

When the activation of the selection and collection subsystem in the above S63 is completed, the selection and collection subsystem (on the learning server 1 side) transmits a data collection request file to the data source 152 (the edge-side device (the fixed camera 3 and the signage 4)) by the image data collection request block 81 in FIG. 9. Upon receiving the data collection request file from the selection and collection subsystem on the learning server 1 side, the data source (edge-side device) 152 transmits data (frame image and information file) from each representative camera to the learning server 1 side and stores the data in the DB 153 of the learning server 1. When the collection of data from each representative camera in the data source (edge-side device) 152 side is completed (YES in S65), (the data source collector module 150 of) the learning server 1 transmits a list (device list) of the representative cameras in each of the grouped groups to the data collector module 151 side as when the clustering (grouping) of above S61 is completed.

The data collector module 151 accesses the data stored in the DB 153 of the learning server 1 on the basis of the received list of representative cameras (device list), performs the processing by the pseudo-labeling block 106 of FIG. 11 (S66), the processing by the processing result block 107 (S67), and result visualization processing by the visualizer 108 (S68) (in short, the evaluation of the quality of the dataset via pseudo-labeling), and determines whether or not the comprehensive evaluation value of the quality of the dataset reaches the KPI (target). As a result of this determination, in a case where the comprehensive evaluation value of the quality of the dataset has not reached the KPI (target) and the number of repetitions has not reached a predetermined limit value (YES in S69), the CPU 31 of the learning server 1 performs processing of complementing the collected data (additionally storing the data in the DB 153 of the learning server 1) from the data source (edge-side device) 152 or processing of removing (deleting) a part of the frame images belonging to the majority of classes from the dataset, and then, in the determination in S69, the processing by the pseudo-labeling block 106, the processing by the processing result block 107, and the result visualization processing by the visualizer 108 (processing in S66 to S68 in FIG. 13) are repeated until the comprehensive evaluation value of the quality of the dataset reaches the KPI (target) or the number of repetitions reaches the predetermined limit value.

Then, in the determination in S69, when the comprehensive evaluation value of the quality of the dataset reaches the KPI (target), the data collector module 151 accesses the data stored in the DB 153 of the learning server 1 on the basis of the received list of representative cameras (device list), performs the processing by the fine tuning block 134 in FIG. 12 (S66), the processing by the processing result block 135 (S67), and the result visualization processing by the visualizer 136 (S68) (in short, the evaluation of the quality of the dataset through fine tuning), and determines whether or not the evaluation value (accuracy of inference processing by the learned DNN model after the fine tuning) reaches the KPI (target). In a case where, as a result of this determination, the accuracy of the inference processing by the learned DNN model after the fine tuning has not reached the KPI (target) and the number of repetitions has not reached the predetermined limit value (YES in S69), the CPU 31 of the learning server 1 complements the collected data (additionally storing the data in the DB 153 of the learning server 1) from the data source (edge-side device) 152, and then repeats the processing by the fine tuning block 134, the processing by the processing result block 135, and the processing of visualizing the result by the visualizer 136 (processing of S66 to S68 in FIG. 13) until the accuracy of the inference processing by the learned DNN model after the fine timing reaches the KPI (target) or the number of repetitions reaches the predetermined limit value in the determination of S69.

In the determination of S69, when the accuracy of the inference processing by the learned DNN model after the fine tuning reaches the KPI (target), it is regarded that the generation of the learning dataset by the present dataset generation system 10 is completed, and the dataset used for the fine tuning is set as the final learning dataset of the DNN model for predetermined inference processing as a target. On the other hand, in the determination in S69, in a case where the number of repetitions reaches the predetermined limit value before the evaluation value (accuracy of inference processing by the comprehensive evaluation value of the quality of the dataset or the learned DNN model after the fine tuning) reaches the KPI (target), the system administrator reviews the design of each subsystem using the data source clustering UI 55 in FIG. 8, the data collection selection UI 72 in FIG. 9, the data quality evaluation UI 93 in FIG. 11, and the data bias evaluation UI 120 in FIG. 12.

From the flows of FIGS. 6 and 13, with the present dataset generation system 10, it is possible to perform the fine tuning of the learned DNN model for inference processing to be used in several 1000 or tens of thousands of stores by using the learning dataset including as few frame images as possible. The reason for this is as follows.
(1) First, the number of frame images to be collected from each camera group is reduced by collecting frame images only from the representative cameras of each camera group using clustering (grouping of cameras). Thus, for example, even in a case where there are many cameras belonging to a certain camera group, the frame images of each camera group are often similar frame images, and thus if the frame images are collected only from the representative cameras (each representative camera) of each camera group and the learning dataset is generated with the collected frame images, the learned DNN model for inference processing fine-tuned using this learning dataset can perform inference with similar accuracy for the frame images of any camera group. Note that, since the frame image used at the time of clustering may be one layout frame image (frame image showing no person) from each camera, the number of frame images used at the time of clustering is small.
(2) Furthermore, by selecting only a frame image having a change (the condition that the number of people has increased, the position of a person has moved, or the posture of the person has changed is satisfied) as viewed from the previous frame image by using the subsystem edited by the data collection selection UI 72, it is possible to efficiently collect frame images having diversity showing a person from the representative camera even if the number of frame images to be collected is small. In fact, the frame images clipped from the recorded captured images are repetitive (repetition of similar frame images), and even collecting successive frame images is of little use. In the subsystem edited by the data collection selection UI 72, it is determined whether the number of people has increased, the position of a person has moved, or the posture of the person has changed as viewed from the previous frame image using the learned DNN model for inference processing, and only the frame image satisfying any one of these conditions is selected, so that it is possible to improve the quality of data while reducing the number of data (frame images) included in the learning dataset and to enhance diversity in data.
(3) In addition, as shown in the flows of FIGS. 6 and 13, after the collection of the minimum necessary number of frame images is completed (YES in S16 in FIG. 6, or YES in S65 in FIG. 13), the complement of the frame image showing a person from each representative camera is repeated until the “comprehensive evaluation value” of the quality of the dataset reaches the KPI (target) in the determination of S19 of FIG. 6, and the evaluation value (F1 score) of the processing result by the learned DNN model after the fine tuning reaches the KPI (target) in the determination of S23 (S20 and S24) (in S20, in a case where there is a bias in the label (class) given to each frame image in the dataset, processing of removing (deleting) a part of the frame images belonging to the majority class from the dataset is also performed). In the complement processing of the frame image described above, since the frame images from the respective representative cameras are added (complemented) to the learning dataset little by little, the data (frame images) included in the learning dataset can be incrementally increased little by little. Then, after the “comprehensive evaluation value” of the quality of the dataset reaches the KPI (target) in the determination of S19, when the evaluation value (F1 score) of the processing result by the learned DNN model after the fine tuning reaches the KPI (target) in the determination of S23, it is possible to stop the collection of the frame images from each representative camera at that time, so that the number of frame images included in the learning dataset can be suppressed as small as possible.
(4) Furthermore, as described above, in the processing of S20 of FIG. 6, as a result of the pseudo-labeling processing, in a case where there is a bias (class imbalance) in the label (class) given to each frame image in the dataset, the CPU 31 of the learning server 1 deletes a part of the frame images belonging to the majority class from the dataset, and thus it is possible to remove redundant learning data (frame image to be deleted and pseudo labels of these frame images) from the learning dataset.

Therefore, it is only necessary to collect 1000 frame images, for example, while 100,000 frame images have to be collected without the above measures (1) to (4).

As described above, according to the dataset generation system 10, the learning server 1, and the dataset generation program 37 of the present embodiment, it is possible to collect frame images meeting the selecting criteria set by the user (in Config fields 87, 88, 109, 110, 137, and 138) using the input device 35 from at least one or more cameras (the fixed camera 3 or the built-in camera 5) in each camera group, and evaluate whether or not a dataset including the frame images collected at that time is suitable for the learning dataset of the DNN model for inference processing as a target (learned DNN model for inference processing of the edge-side device). Thus, when the evaluation value (comprehensive evaluation value) of the dataset including the frame images collected at that time is equal to or more than the target value (when reaching KPI (target)), the collection of the frame images is ended, and the dataset composed of the frame images collected at that time can be set as the learning dataset of the DNN model for inference processing as a target, so that the number of frame images included in the learning dataset of the DNN model for inference processing as a target can be reduced as much as possible. Therefore, it is possible to perform machine learning of the DNN model for inference processing as a target targeting the frame images of cameras of facilities such as numerous stores using as few frame images as possible. Therefore, the processing time required for generating the learning dataset of the DNN model for inference processing as a target and the processing time required for machine learning of the DNN model for inference processing using this learning dataset can be shortened, and the cost required for transferring the frame image of the camera from the camera side (edge device side) to the learning server 1 (communication cost, electricity cost, and the like) and the cost required for storing the frame image received by the learning server 1 from the edge device side (cost required for securing the storage area in the learning server 1) can be reduced.

In addition, according to the dataset generation system 10 of the present embodiment, the representative camera in each of the grouped camera groups is selected, and frame images meeting the selecting criteria set by the user are collected from each of the selected representative cameras. Thus, since the frame images meeting the selecting criteria can be collected only from the representative camera in each camera group, the number of frame images included in the learning dataset of the DNN model for inference processing as a target can be reliably reduced.

In addition, according to the dataset generation system 10 of the present embodiment, frame images in which the number of people has increased, the position of a person has moved, or the posture of the person has changed as viewed from the previous frame image are collected. As described above, by selecting only a frame image having a change as viewed from the previous frame image, frame images having diversity can be efficiently collected from the camera (the fixed camera 3 or the built-in camera 5) even if the number of frame images to be collected is small.

Further, according to the dataset generation system 10 of the present embodiment, when the “comprehensive evaluation value” of the quality of the dataset reaches the KPI (target), the learned DNN model for inference processing as a target is fine-tuned using the dataset composed of the frame images collected at this point of time as the learning dataset, and it is evaluated whether or not the accuracy of the inference processing by the learned DNN model after the fine tuning is improved by a predetermined value or more than the accuracy of the inference processing by the learned DNN model before the fine tuning. As described above, it is possible to evaluate whether or not the dataset composed of the frame images collected from respective cameras is suitable for the learning dataset for fine tuning of the DNN model for inference processing as a target on the basis of the result of the evaluation inference processing (for example, the pseudo-labeling processing), but when fine tuning of the learned DNN model for inference processing as a target is performed using the dataset evaluated to be suitable for the learning dataset for fine tuning as the learning dataset, in practice, the accuracy of the inference processing by the learned DNN model after the fine tuning may not be improved as expected. Therefore, as described above, unless it is confirmed whether or not the accuracy of the inference processing by the learned DNN model after the fine tuning is improved by a predetermined value or more than the accuracy of the inference processing by the learned DNN model before the fine tuning by performing the fine tuning of the learned DNN model for inference processing as a target using the dataset in which the “comprehensive evaluation value” of the quality has reached the KPI (target) (the dataset which is evaluated to be suitable for the learning dataset for fine tuning of the learned DNN model for inference processing as a target) as the learning dataset, it is not possible to make a final determination as to whether or not the dataset in which the “comprehensive evaluation value” of the quality has reached the KPI (target) may be employed as the learning dataset for fine tuning of the learned DNN model for inference processing as a target.

In addition, according to the dataset generation system 10 of the present embodiment, the pseudo-labeling processing is performed on each of the frame images collected from respective cameras, and the fine tuning of the learned DNN model for inference processing as a target is performed on the basis of the frame images collected from respective cameras and the correct answer label given to the frame image by the pseudo-labeling processing. As described above, since the correct answer label is given to the collected frame image using the pseudo-labeling processing, the fine tuning of the teamed DNN model for inference processing as a target can be automatically performed.

Further, according to the dataset generation system 10 of the present embodiment, a frame image (layout frame images) showing no person is collected from each of the plurality of cameras, features are extracted from each of the collected frame images, and the collected frame images are grouped on the basis of the extracted features. Then, on the basis of the grouping result of the collected frame images, the cameras that have captured these frame images are grouped. Thus, when the collected frame images are grouped, it is possible to remove the influence of people appearing in the frame images, and thus it is possible to group the cameras that have captured the frame images on the basis of the features for the frame images of the facilities such as the stores captured by the cameras.

Modifications:

Note that the present invention is not limited to the configuration of each of the above embodiments, and various modifications can be made without changing the gist of the invention. Next, a modification of the present invention will be described.

Modification 1:

In the above embodiment, when the “comprehensive evaluation value” of the quality of the dataset reaches the KPI (when the evaluation value of the quality of the dataset becomes equal to or more than the target value), the learned DNN model for inference processing as a target is fine-tuned using the dataset composed of the frame images collected at this point of time as the learning dataset, and it is evaluated whether or not the accuracy of the inference processing by the learned DNN model after the fine tuning is improved by a predetermined value or more than the accuracy of the inference processing by the learned DNN model before the fine tuning. However, in the present invention, it is not always necessary to evaluate whether or not the accuracy of the inference processing by the learned DNN model after the fine tuning is improved by a predetermined value or more as compared with the accuracy of the inference processing by the learned DNN model before the fine tuning, and when the evaluation value of the quality of the dataset becomes equal to or more than the target value, a dataset composed of frame images having been collected at this point of time may be employed as the learning dataset for fine tuning of the learned DNN model for inference processing as a target.

Modification 2:

In the above embodiment, on the basis of the result of the pseudo-labeling processing on the frame images collected from respective cameras, whether or not the dataset composed of the frame images collected from respective cameras is suitable for the learning dataset for fine tuning of the DNN model for predetermined inference processing as a target is evaluated. However, the present invention is not limited thereto, and it is sufficient that inference processing for evaluation is performed on each of the frame images collected from respective cameras, and whether or not the dataset composed of the frame images collected from respective cameras is suitable as the learning dataset of the DNN model for inference processing as a target is evaluated on the basis of results of the inference processing.

Modification 3:

In the above embodiment, the representative camera in each of the grouped (camera) groups is selected, and a frame image meeting the selecting criteria set using the input device 35 is collected from each of the selected representative cameras. However, the present invention is not limited thereto, and frame images meeting the selecting criteria set using the input device may be collected from a plurality of cameras in each grouped (camera) group.

Modification 4:

In the above embodiment, frame images in which the number of people has increased, the positions of more than a predetermined percent of persons have moved, or the postures of more than a predetermined percent of persons have changed, as viewed from the previous frame image are collected, but the present invention is not limited to this. For example, frame images in which the number of people has increased or decreased, the position of at least one person has moved, or the posture of at least one person has changed as viewed from the previous frame image may be collected, or frame images in which the number of people has increased, or the positions of more than a predetermined percent of persons have moved, as viewed from the previous frame image may be collected.

Modification 5:

In the above embodiment, an example in which the “relearning” in the claims is fine tuning has been described, but the “relearning” in the present invention is not limited thereto, and may be transfer learning, for example. Here, the transfer learning means to learn only the weight of a newly added layer while fixing the weight in the original (existing) learned DNN model.

Modification 6:

In the above embodiment, the example in which the edge-side device to which the camera is connected is the signage 4 and the analysis box 2 has been described, but the edge-side device is not limited thereto and may be, for example, what is called an AI camera.

These and other modifications will become obvious, evident or apparent to those ordinarily skilled in the art, who have read the description. Accordingly, the appended claims should be interpreted to cover all modifications and variations which fall within the spirit and scope of the present invention.

1. A dataset generation system comprising:
a camera classification circuitry configured to classify plural cameras into plural groups;
an input device for a user to set a selecting criterion of a captured image;
a first captured image collection circuitry configured to collect captured images which are captured by at least one camera in each group classified by the camera classification circuitry, and which meet the selecting criterion set by a user using the input device;
an inference circuitry configured to perform inference processing on each of the captured images collected by the first captured image collection circuitry; and
a dataset evaluation circuitry configured to evaluate whether or not a dataset consisting of the captured images collected by the first captured image collection circuitry is suitable for a training dataset of a neural network model for a predetermined inference process, based on the result of the inference processing by the inference circuitry.

2. The dataset generation system according to claim 1, further comprising a representative camera selection circuitry configured to select a representative camera in each group classified by the camera classification circuitry,
wherein the first captured image collection circuitry collects captured images, which meet the selecting criterion set by a user using the input device, from respective representative cameras selected by the representative camera selection circuitry.

3. The dataset generation system according to claim 1,
wherein the first captured image collection circuitry collects captured images in which, seen from the previous captured image, there is an increase or a decrease in the number of recognized objects, or a change in the position or posture of at least one recognized object.

4. The dataset generation system according to claim 1,
wherein the dataset evaluation circuitry evaluates whether or not the dataset consisting of the captured images collected by the first captured image collection circuitry is suitable for the training dataset to be used for fine-tuning or transfer learning of a learned neural network model for the predetermined inference process, based on the result of the inference processing by the inference circuitry, and
wherein the dataset generation system further comprises:
a relearning circuitry configured to perform fine-tuning or transfer learning (hereafter collectively referred to as “relearning”) of a learned neural network model for the predetermined inference process by using the dataset consisting of the captured images collected by the first captured image collection circuitry as the training dataset, only when the evaluation value of the dataset by the dataset evaluation circuitry has reached the target value; and
an accuracy improvement evaluation circuitry configured to evaluate whether or not an accuracy of the inference process by the learned neural network model after relearning by the relearning circuitry is improved equal to or more than a predetermined value compared to an accuracy of the inference process by the learned neural network model before the relearning by the relearning circuitry.

5. The dataset generation system according to claim 4, further comprising a pseudo-labeling circuity configured to give pseudo-labels to each of the captured images collected by the first captured image collection circuitry,
wherein the relearning circuitry relearns the learned neural network model for the predetermined inference process, based on both the captured images collected by the first captured image collection circuitry and the pseudo-labels given to each of the captured images by the pseudo-labeling circuitry.

6. The dataset generation system according to claim 1, further comprising a second captured image collection circuitry configured to collect captured images, which show no recognition target, from each of the plural cameras;
an image feature extraction circuitry for extracting features from each of the captured images which are collected by the second captured image collection circuitry and show no recognition target; and
an image clustering circuitry configured to perform grouping of the captured images which are collected by the second captured image collection circuitry and show no recognition target, based on the features of each of the captured images, extracted by the image feature extraction circuitry,
wherein based on a result of the grouping of the captured images, which show no recognition target, by the image clustering circuity, the camera classification circuitry classifies cameras having captured the captured images into groups, so as to classify the plural cameras into the plural groups.

7. The dataset generation system according to claim 1,
wherein when the evaluation value of the dataset by the dataset evaluation circuitry has reached the target value, the dataset consisting of the captured images that has been already collected by the first captured image collection circuitry at that time is used as the training dataset of the neural network model for the predetermined inference process.

8. A server connected to plural cameras through a network, the server comprising:
a camera classification circuitry configured to classify the plural cameras into plural groups;
an input device for a user to set a selecting criterion of a captured image;
a first captured image collection circuitry configured to collect captured images which are captured by at least one camera in each group classified by the camera classification circuitry, and which meet the selecting criterion set by a user using the input device;
an inference circuitry configured to perform inference processing on each of the captured images collected by the first captured image collection circuitry; and
a dataset evaluation circuitry configured to evaluate whether or not a dataset consisting of the captured images collected by the first captured image collection circuitry is suitable for a training dataset of a neural network model for a predetermined inference process, based on the result of the inference processing by the inference circuitry.

9. A non-transitory computer-readable recording medium for recording a dataset generation program to cause a computer to execute a process including the steps of:
classifying plural cameras into plural groups;
collecting captured images which are captured by at least one camera in each of the classified groups, and which meet the selecting criterion set by a user using an input device;
performing inference processing on each of the collected captured images; and
evaluating whether or not a dataset consisting of the collected captured images is suitable for a training dataset of a neural network model for a predetermined inference process, based on the result of the inference processing.
